(19) United States
(12) Patent Application Publication
(10) Pub. No.: US 2014/0011022 A1
(43) Pub. Date: Jan. 9, 2014

(54) PRESSURE-SENSITIVE ADHESIVE SHEET AND USE THEREOF

(71) Applicants: Natsuki Ukei, Ibaraki-shi (JP); Kenichi Kataoka, Ibaraki-shi (JP); Hiromoto Haruta, Ibaraki-shi (JP); Kenjiro Niimi, Ibaraki-shi (JP); Tatsumi Amano, Ibaraki-shi (JP)

(72) Inventors: Natsuki Ukei, Ibaraki-shi (JP); Kenichi Kataoka, Ibaraki-shi (JP); Hiromoto Haruta, Ibaraki-shi (JP); Kenjiro Niimi, Ibaraki-shi (JP); Tatsumi Amano, Ibaraki-shi (JP)

(73) Assignee: NITTO DENKO CORPORATION, Ibaraki-shi, Osaka (JP)

(21) Appl. No.: 14/006,214

(22) PCT Filed: Feb. 28, 2012
(86) PCT No.: PCT/JP2012/054952

§ 371 Date: Sep. 19, 2013

(30) Foreign Application Priority Data
Mar. 29, 2011 (JP) 2011-073224

(51) Int. Cl. C09J 7/02

(52) U.S. Cl. CPC C09J 7/0217
USPC 428/336; 428/354

(57) ABSTRACT

The present invention provides a PSA sheet combining higher levels of antistaticity, anchoring and less contaminating nature. The PSA sheet comprises a substrate film formed from a resin material, a pressure-sensitive adhesive layer provided on a first face thereof, and an antistatic layer provided between the first face and the pressure-sensitive adhesive layer. The antistatic layer comprises an antistatic ingredient ASu. The pressure-sensitive adhesive layer comprises an acrylic polymer as a base polymer, and an ionic compound as an antistatic ingredient ASp.

### TECHNICAL FIELD

The present invention relates to a pressure-sensitive adhesive (PSA) sheet comprising a PSA layer on top of a film formed from a resin material, and in particular, it relates to a PSA sheet having antistaticity. The PSA sheet according to the present invention is particularly preferable for applications where it is adhered to plastic products, etc., which are likely to generate static electricity. In particular, it is useful as a surface protection film used for protecting surfaces of optical components (e.g., polarizing plates, wave plates, retardation plates, optical compensation films, reflective sheets, brightening films used in liquid crystal displays) and the like. The present application claims priority based on Japanese Patent Application No. 2011-073224 filed on Mar. 29, 2011, and the entire contents thereof are incorporated in the present application by reference.

### BACKGROUND ART

Surface protection film (which may be referred to as surface protection sheet as well) is generally constructed to comprise a PSA provided on a face of a support (substrate) film. Such surface protection film is adhered to an adherend (article to be protected) via the PSA, and by this means, it is used for protecting the adherend from scratches and dirt during manufacturing, transport, and so on. For example, a liquid crystal display panel is formed by adhering optical components such as a polarizing plate, wave plate, etc., to a liquid crystal cell via the PSA. In manufacturing of such liquid crystal display panels, a polarizing plate to be adhered on a liquid crystal cell is first produced as a roll, and then when used, it is unreeled to be cut into desirable dimensions corresponding to the liquid crystal cell shape. Here, as a measure taken to prevent the polarizing plate from scratches, which can be caused by friction with conveying rollers during intermediate processing procedures, a surface protection film is adhered to one or each (typically one) face of the polarizing plate. The surface protection film is peeled away when it is no longer necessary.

As such a surface protection film, a transparent type is preferable since it allows one to perform visual inspection of adherends (e.g., polarizing plates) with the surface protection film being adhered thereon. A polyester film typified by polyethylene terephthalate (PET) is preferable as the substrate of a surface protection film in view of the mechanical strength, size stability, optical properties (e.g., transparency), and so on. However, polyester films are highly electrically insulating and generate static electricity upon friction or peeling. Thus, static electricity is likely to be generated also when the surface protection film is peeled away from optical components such as polarizing plates, etc.; and if the static electricity is left to apply a voltage to the liquid crystal, the orientation of liquid crystal molecules may be impaired or the panel may suffer defects. The presence of static electricity may attract dusts or may become a cause to lower the workability.

Due to such circumstances, surface protection film (e.g., surface protection film for optical components) is subjected to antistatic treatments. Technical literature related to this type of art includes Patent Documents 1 to 5. Patent Documents 1 to 4 relate to techniques to provide antistatic properties by placing a layer having antistaticity (an antistatic layer) between a resin film as a substrate and a PSA layer. Patent Document 5 relates to an art of providing antistaticity by inclusion of an antistatic ingredient in a PSA.

### CITATION LIST

### Patent Literature

[Patent Document 1] Japanese Patent Application Publication No. 2000-085068
[Patent Document 2] Japanese Patent Application Publication No. 2005-290287
[Patent Document 3] Japanese Patent Application Publication No. 2005-200607
[Patent Document 4] Japanese Patent Application Publication No. 2006-126429
[Patent Document 5] Japanese Patent Application Publication No. 2006-291172

### SUMMARY OF INVENTION

### Technical Problem

With respect to a PSA sheet constructed to have an antistatic layer between a substrate and a PSA layer, when the PSA sheet is peeled away from adherends, although an effect of suppressing static generation can be realized in the PSA sheet itself, it is hard to obtain a notable effect of suppressing static generation during peeling in the adherend side, with the adherend being not pre-subjected to an antistatic treatment. Depending on the embodiment of the antistatic layer, the anchoring of the PSA layer may tend to turn out poorer as well. On the other hand, in a PSA sheet constructed to contain an antistatic ingredient in the PSA, if the antistatic ingredient content in the PSA is increased excessively in order to increase the antistaticity for the adherend side, contamination of the adherend due to the antistatic ingredient is likely to occur (impairing the less contaminating nature).

The present invention has been made in view of such circumstances, and an objective thereof is to provide a PSA sheet combining higher levels of antistaticity, anchoring and less contaminating nature.

### Solution to Problem

The PSA sheet disclosed herein comprises a substrate film (e.g., a polyester film) formed from a resin material, a PSA layer provided on one face (or the “first face” hereinafter) of the film, and an antistatic layer provided between the first face of the film and the PSA layer. The PSA layer comprises an acrylic polymer as a base polymer, and an ionic compound as an antistatic ingredient ASp. The antistatic layer comprises an antistatic ingredient ASu.

According to the art disclosed herein, by the combined effect from providing the first face of the film with an antistatic layer and including an ionic compound as an antistatic ingredient in the PSA layer disposed on the antistatic layer, it is possible to obtain a PSA sheet combining higher levels of antistaticity (e.g., antistaticity for the adherend side), anchoring and less contaminating nature. Such a PSA sheet is preferable for use as a surface protection film (in particular, a surface protection film for components that should avoid static electricity, such as polarizing plates, etc.) and for other applications. The PSA layer comprising an acrylic polymer as a base polymer (being an acrylic PSA layer) is advantageous in increasing the transparency (further, the suitability for visual inspectations) of the PSA sheet. Thus, the PSA sheet disclosed herein is suitable for use as a surface protection film (e.g., a surface protection film for optical components) and for other applications that are used in embodiments where visual inspections of products are performed through the PSA sheet.

According to the PSA sheet disclosed herein, by the combined effect, despite that the antistatic layer has a relatively small thickness (e.g., having an average thickness Dave of, for instance, 2 nm or larger, but smaller than 1 μm, i.e., 2 nm≦Dave<1 μm), sufficient antistaticity can be obtained. As compared to a PSA sheet having a thicker antistatic layer, such a PSA layer may exhibit greater anchoring between the PSA layer and the substrate. Thus, when the PSA sheet is peeled away from an adherend, it is possible to more highly prevent the event (adhesive transfer) where the antistatic layer and the PSA layer are separated from the substrate, and the PSA is left on the adherend surface.

As the substrate film, can be preferably used a plastic film (e.g., a polyester film) formed from a thermoplastic resin material. A preferable film is formed from a transparent resin material. Preferable examples include transparent polyester films.

Herein, the polyester film refers to a film comprising, as a primary resin component, a polymer material (polyester resin) having a main backbone based on ester bonds, such as polyethylene terephthalate (PET), polyethylene naphthalate (PEN), polybutylene terephthalate, and the like. While such polyester film has properties preferable as a substrate in a PSA sheet (in particular, a surface protection film that may be used in an embodiment where visual inspections of products are performed through the film; e.g., a surface protection film for optical components), with it exhibiting great optical properties and size stability, etc., it is naturally susceptible to static generation as is. Thus, with a PSA sheet comprising a polyester film as a substrate, it is particularly meaningful to provide antistaticity by applying the art disclosed herein.

As the ionic compound (antistatic ingredient ASp) contained in the PSA layer, at least either an ionic liquid or an alkali metal salt can be preferably used. The ionic liquid may be, for instance, one, two or more species among nitrogen-containing onium salts (pyridinium salts, imidazolium salts, etc.), sulfur-containing onium salts, and phosphorous-containing onium salts. As the alkali metal salt, a lithium salt can be preferably used.

As the antistatic ingredient ASu contained in the antistatic layer, various antistatic agents can be used. In a preferable embodiment, the antistatic ingredient ASu comprises any one, or two or more of polythiophenes, quaternary ammonium salt-containing polymers and tin oxide. According to such an embodiment, higher levels of antistaticity, anchoring and less contaminating nature may be attained at the same time.

### BRIEF DESCRIPTION OF DRAWINGS

FIG. 1 shows a schematic cross-sectional view illustrating a constitution example of the PSA sheet according to the present invention.

FIG. 2 shows a schematic cross-sectional view illustrating another constitution example of the PSA sheet according to the present invention.

FIG. 3 shows a diagram illustrating a method for measuring static voltage generated upon peeling.

### EMBODIMENTS OF INVENTION

Preferred embodiments of the present invention are described below. Matters necessary to practice this invention other than those specifically referred to in this description may be understood as design matters based on the conventional art in the pertinent field for a person of ordinary skills in the art. The present invention can be practiced based on the contents disclosed in this description and common technical knowledge in the subject field.

The embodiments shown in the figures are schematically drawn in order to clearly illustrate the present invention and are not of accurate representations of dimensions and scales of the PSA sheet to be provided as an actual product of this invention.

### <Overall Constitution of PSA Sheet>

The PSA sheet disclosed herein may take forms of those generally called as PSA tape, PSA label, PSA film, etc. Since visual inspections of products can be performed accurately through the PSA sheet, it is preferable especially as a surface protection film to protect surfaces of optical components during manufacturing and transport of the optical components (e.g., optical components used as constituents of liquid crystal display panels, such as polarizing plates, wave plates, etc.). The PSA layer in the PSA sheet typically has, but not limited to a continuous form, and may have, for instance, a regular or a random pattern of dots, stripes, and so on. The PSA sheet disclosed herein may be present as a roll or a flat sheet.

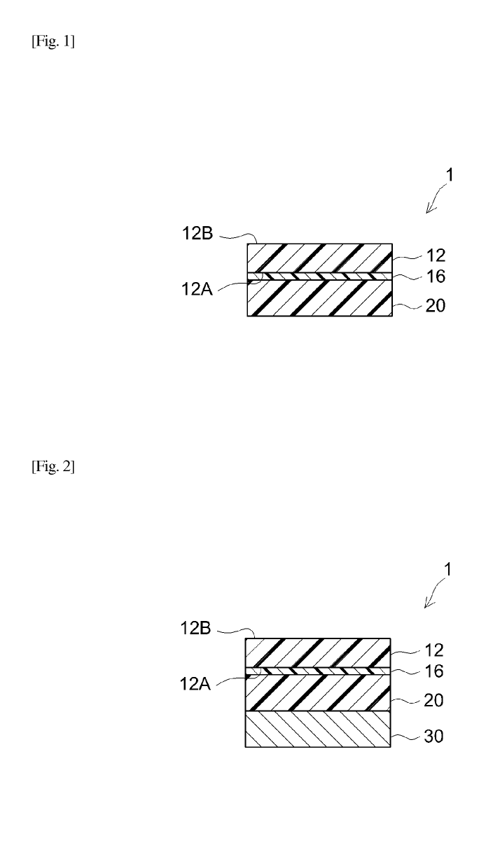

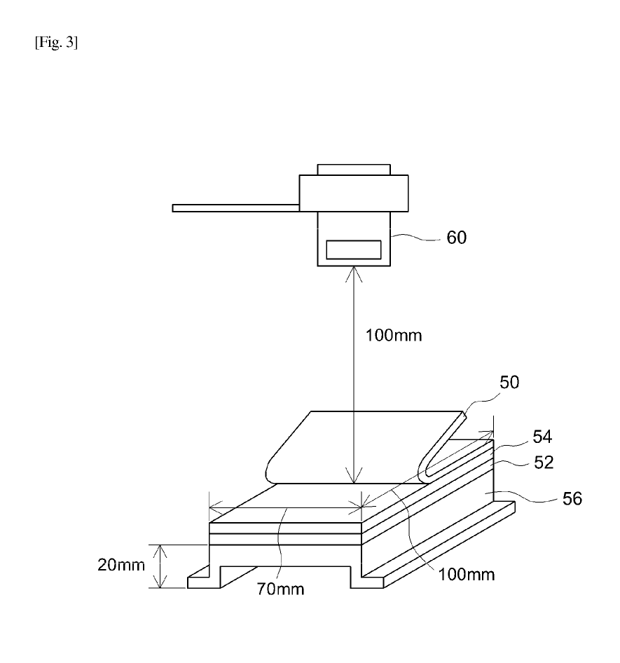

FIG. 1 shows a typical constitution example of the PSA sheet disclosed herein. The PSA sheet 1 comprises a resinous substrate film (e.g., a polyester film) 12, an antistatic layer provided on top of a first face 12A thereof, and a PSA layer 20 further provided on top thereof. The PSA sheet 1 is used by adhering PSA layer 20 to an adherend (an article to be protected when PSA sheet 1 is used as a surface protection film, e.g., surfaces of optical components such as polarizing plates, etc.). PSA sheet 1 prior to use (i.e., before adhered to an adherend) may be in a state, typically as shown in FIG. 2, where the surface (surface to be adhered to the adherend) of PSA layer 20 is protected with a release liner 30 having a release face at least on the PSA layer 20 side. Alternatively, PSA sheet 1 may be wound in a roll to be in a state where the backface (second face) 12B of film 12 is in contact with and protects the PSA layer surface.

### <Substrate Film>

The resin material constituting the substrate film in the art disclosed herein can be anything as long as it can form a sheet or film, and is not particularly limited. A preferable resin material is able to constitute film that exhibits excellence in one, two or more properties among transparency, mechanical strength, thermal stability, waterproofing ability, isotropy, size stability, etc. For example, as the substrate film, a preferable resin film is constituted from a resin material comprising, as the primary resin component (i.e., a primary component among resin components, typically a component accounting for 50% by mass or greater), a polyester-based polymer such as polyethylene terephthalate (PET), polyethylene naphthalate, polybutylene terephthalate, etc.; a cellulose-based polymer such as diacetyl cellulose, triacetyl cellulose, etc.; a polycarbonate-based polymer; an acrylic polymer such as polymethyl methacrylate, etc.; or the like. Other examples of the resin material include those formed from resin materials such as styrene-based polymers including polystyrene, acrylonitrile-styrene copolymers, etc.; olefin-based polymers including polyethylene, polypropylene, polyolefins having a cyclic or a norbornene structure, ethylene-propylene copolymers, etc.; vinyl chloride-based polymers; amide-based polymers including nylon 6, nylon 6,6, aromatic polyamides, etc.; and the like. Yet other examples of the resin material include imide-based polymer, sulfone-based polymers, polyethersulfone-based polymers, polyether ether ketone-based polymers, polyphenylene sulfide-based polymers, vinyl alcohol-based polymers, vinylidene chloride-based polymer, vinyl butyral-based polymers, acrylate-based polymers, polyoxymethylene-based polymer, epoxy-based polymers, and so on. It may be substrate film formed from a blend of two or more species among the polymers listed above.

With respect to the substrate film, the smaller the anisotropy of optical properties (phase contrast, etc.) are, the more preferable it is. Especially with a substrate film for use in a surface protection film for optical components, it is advantageous to reduce the optical anisotropy. In view of being heat resistant and solvent resistant while being flexible to provide excellent moldability, a film formed from a thermoplastic resin material can be preferably used. The film may be a non-stretched type or a stretched (uniaxially stretched, biaxially stretched, etc.) type. It may have a single layer structure, or a structure consisting of overlaid multiple layers having different compositions.

The thickness of the substrate film can be suitably selected in accordance with the applications or purposes of the PSA sheet. For the balance between the workability including the strength, handling properties, etc., and the cost and visual inspectability, etc., it is usually suitable to be about 10 μm to 200 μm, preferably about 15 μM to 100 μm, or more preferably about 18 μm to 75 μm. It is usually preferable that the film (e.g., a polyester film) has a light transmittance of 70% to 99%, or more preferably 80% to 99% (e.g., 85% to 99%).

The resin material constituting the substrate film may contain various additives as necessary such as antioxidants, ultraviolet (UV)-ray absorbing agents, plasticizers, colorants (pigments, dyes, etc.) and the like. The first face (the surface on the side to be provided with an antistatic layer) of the film may have been subjected to a known or commonly employed surface treatment such as a corona discharge treatment, plasma treatment, UV-ray irradiation, acid treatment, base treatment, or the like. These surface treatments may be given, for instance, to increase the adhesion between the film and the antistatic layer. A preferably employed surface treatment introduces a polar group such as hydroxyl group (—OH group), etc., to the film surface. The second face (backface) of the substrate film may have been subjected to a known or commonly employed surface treatment, or may have an untreated (original) surface. The surface treatments to which the second face may be subjected include a treatment to introduce a polar group to the surface, a treatment (release treatment) to increase the releasability of the surface, and so on.

### <Composition of Antistatic Layer (Antistatic Ingredient ASu)>

The PSA sheet disclosed herein has an antistatic layer containing an antistatic ingredient (a component that works to prevent static generation in the PSA sheet) ASu on one face (the first face) of the film. As the antistatic ingredient ASu, can be used, for instance, a conductive organic or inorganic substance, various kinds of antistatic agent, and the like.

Examples of the conductive organic substances include a cationic antistatic agent having a cationic functional group such as quaternary ammonium group, pyridinium group, primary amine group, secondary amine group, tertiary amine group, etc.; an anionic antistatic agent having an anionic functional group such as sulfonate group, sulfate group, phosphonate group, phosphate group, etc.; zwitterionic antistatic agents such as alkyl betaines and derivatives thereof, imidazoline and derivatives thereof, alanine and derivatives thereof, etc.; nonionic antistatic agents such as amino alcohols and derivatives thereof, glycerin and derivatives thereof, polyethylene glycol and derivatives thereof, etc.; ion-conductive polymers obtained by polymerizing or copolymerizing a monomer species having the cationic, anionic or zwitterionic ion-conductive group (e.g., quaternary ammonium group); conductive polymers such as polythiophene, polyaniline, polypyrrol, polyethyleneimine, allylamine-based polymers, etc. Among these antistatic agents, can be used one species alone, or two or more species in combination.

Examples of the conductive inorganic substances include tin oxide, antimony oxide, iridium oxide, cadmium oxide, titanium oxide, zinc oxide, indium, tin, antimony, gold, silver, copper, aluminum, nickel, chromium, titanium, iron, cobalt, copper iodide, ITO (iridium oxide/tin oxide), ATO (antimony oxide/tin oxide) and the like. Among these conductive inorganic substances, can be used one species alone, or two or more species in combination.

The art disclosed herein can be practiced preferably in an embodiment where the antistatic ingredient ASu comprises a conductive polymer wherein the conductive polymer comprises one or both of a polythiophene and a polyaniline. A preferable polythiophene has a weight average molecular weight (or “Mw” hereinafter) of 40×10⁴ or smaller based on standard polystyrene, or more preferably 30×10⁴ or smaller. The polyaniline has a Mw of preferably 50×10⁴ or smaller, or more preferably 30×10⁴ or smaller. The Mw values of these conductive polymers are usually preferable to be 0.1×10⁴ or greater, or more preferable to be 0.5×10⁴ or greater. In this description, polythiophene refers to a polymer of a non-substituted thiophene or substituted thiophene. Poly(3,4-ethylenedioxythiophene) can be cited as a preferable example of a substituted thiophene polymer in the art disclosed herein.

In the antistatic layer having a composition containing a binder resin besides such a conductive polymer, the amount of the conductive polymer used can be, for instance, 10 to 300 parts by mass relative to 100 parts by mass of the binder resin constituting the antistatic layer, and it is usually suitable to be 20 to 200 parts by mass. Too small an amount of the conductive polymer may tend to result in insufficient antistaticity of the PSA sheet. Too large an amount of the conductive polymer may tend to result in poorer adhesion (anchoring) between the antistatic layer and the substrate.

As a method for forming the antistatic layer, can be preferably employed a method where a liquid composition (a coating composition for forming antistatic layers) is applied to a substrate film and allowed to dry or cure. As for the conductive polymer used for preparation of the liquid composition, can be preferably used a solution or dispersion of the conductive polymer in water (aqueous conductive polymer solution). Such an aqueous conductive polymer solution can be prepared, for instance, by dissolving or dispersing in water a hydrophilic functional group-containing conductive polymer (which can be synthesized by copolymerization of a monomer species containing a hydrophilic functional group within the molecule, or by like methods). Examples of the hydrophilic functional group include sulfo group, amino group, amide group, imino group, hydroxyl group, mercapto group, hydrazino group, carboxyl group, quaternary ammonium group, sulfate group (—O—SO₃H), phosphate group (e.g., —O—PO(OH)₂), and so on. Such a hydrophilic functional group may be present in a form of a salt. Examples of a commercially available aqueous polythiophene solution include trade name “DENATRON” series available from Nagase ChemteX Corporation. Examples of a commercially available aqueous polyaniline sulfonate solution include trade name “AQUA-PASS” available from Mitsubishi Rayon Co., Ltd.

In a preferable embodiment, an aqueous polythiophene solution is used to prepare the coating composition. An aqueous polythiophene solution containing a polystyrene sulfonate (PSS) (which may be in a form where a PSS is added as a dopant to a polythiophene) is preferably used. Such an aqueous solution may contain a polythiophene and a PSS at a weight ratio of 1:5 to 1:10. Examples of commercially available aqueous polythiophene solutions of this sort include trade name “BAYTRON” available from H. C. Stark GmbH.

When an aqueous polythiophene solution containing a PSS is used as described above, the combined amount of the polythiophene and the PSS can be 10 to 300 parts by mass (usually, 20 to 200 parts by mass, e.g., 30 to 150 parts by mass) relative to 100 parts by mass of the binder resin.

The art disclosed herein is practiced preferably in an embodiment where the antistatic ingredient ASu comprises a conductive polymer, with the conductive polymer comprising at least a polymer containing a quaternary ammonium salt. A preferable example of the quaternary ammonium salt group-containing polymer is a conductive polymer comprising, as a copolymerized component, a monomer having at least one quaternary ammonium salt group and at least one (meth)acryloyl group per molecule (or “a quaternary ammonium salt group-containing acrylic monomer”, hereinafter). The quaternary ammonium salt group is typically represented by equation: —N⁺(R¹¹R¹²R¹³).X⁻. Here, R¹¹, R¹² and R¹³ individually represent a hydrogen atom or a hydrocarbon group (e.g., a hydrocarbon group having 1 to 10 carbon atoms), with them being the same or different. The hydrocarbon group may be, for instance, an alkyl group, an aryl group, or a cycloalkyl group, etc. Preferable examples of the alkyl group include alkyl groups having 1 to 6 (more preferably 1 to 4, especially 1 to 3) carbon atoms, such as methyl group, ethyl group, propyl group, isopropyl group, n-butyl group, isobutyl group, s-butyl group, t-butyl group, pentyl group, isopentyl group, hexyl group and the like. X⁻ is an organic or inorganic anion, and may be, for example, a halide ion, R²¹OSO₃⁻ (R²¹ is a hydrocarbon group), or R²²SO₃⁻ (R²² is a hydrocarbon group), OH⁻, HCO₃⁻, CO₃²⁻, SO₄²⁻, R²³COO⁻ (R²³ is a hydrocarbon group), or the like.

The copolymerization ratio of quaternary ammonium salt group-containing acrylic monomer in such a quaternary ammonium salt group-containing polymer can be suitably selected from a range of 1% by mass or greater (typically 1 to 100% by weight) relative to the total amount of monomers. In a preferable quaternary ammonium salt group-containing polymer, the copolymerization ratio of quaternary ammonium salt group-containing acrylic monomer is usually 5 to 90% by mass (preferably 10 to 80% by mass, e.g., 10 to 70% by weight).

Examples of commercially available antistatic agents containing a quaternary ammonium salt group-containing conductive polymer as an active ingredient (antistatic ingredient) include trade names “BONDEIP” seriese (BONDEIP-P, BONDEIP-PA, BONDEIP-PX, etc.) available from Konishi Co., Ltd.

The art disclosed herein can be practiced preferably in an embodiment where the antistatic ingredient ASu comprises a conductive inorganic substance, with the conductive inorganic substance comprising at least tin oxide. Other conductive inorganic substances containing tin oxide include ITO (iridium oxide/tin oxide), ATO (anitimony oxide/tin oxide), and the like.

In an antistatic layer having a composition containing a binder resin besides such a conductive inorganic substance, the amount of the conductive inorganic substance used can be, for instance, 50 to 400 parts by mass relative to 100 parts by mass of the binder resin constituting the antistatic layer, or it is usually suitable to be 100 to 300 parts by mass. Too small an amount of conductive inorganic substance may result in insufficient antistaticity of the PSA sheet. Too large an amount of conductive inorganic substance may result in poorer adhesion (anchoring) between the antistatic layer and the substrate.

### <Composition of Antistatic Layer (Binder Resin)>

The antistatic layer may comprise a binder resin besides an antistatic ingredient ASu. The binder resin may be one, two or more species of resin selected among various types of resin such as heat-curable resins, UV-curable resins, electron beam-curable resins, two part resins, and the like. It is preferable to select a resin capable of forming highly light-transmitting antistatic layers.

Specific examples of heat-curable resins include resins comprising, as a base resin, an acrylic resins, acrylic-urethane resin, acrylic-styrene resin, acrylic-silicon resin, silicone resin, polysilazane resin, polyurethane resin, fluorine contained resin, polyester resin, polyolefin resin or the like. Among these, can be preferably used heat-curable resins such as acrylic resins, acrylic-urethane resins, acrylic-styrene resins and the like.

Specific examples of UV-curable resins include monomers, oligomers, polymers of various types of resins such as polyester resins, acrylic resins, urethane resins, amide resins, silicone resins, epoxy resins etc., and also mixtures of these. For the great UV-curability, it is preferable to use a UV-curable resin containing a polyfunctional monomer having two or more (more preferably 3 or more, e.g., about 3 to 6) UV-polymerizable functional groups per molecule and/or an oligomer thereof. As the polyfunctional monomer, can be preferably used acrylic monomers such as polyfunctional acrylates, polyfunctional methacrylates, and the like.

In an embodiment of the art disclosed herein, the binder resin is a resin (an acrylic resin) comprising an acrylic polymer as a base polymer (a primary component among polymer components, i.e., a component accounting for 50% by mass or greater). The term “acrylic polymer” herein refers to a polymer constituted with a monomer having at least one (meth)acryloyl group per molecule (which may be referred to as “acrylic monomer” hereinafter), with the monomer being the primary monomeric component (the primary component among monomers, i.e., a monomer accounting for 50% by mass or greater of the total amount of monomers constituting the acrylic polymer).

In the present description, the term “(meth)acryloyl group” comprehensively refers to acryloyl group and methacryloyl group. Similarly, the term “(meth)acrylate” comprehensively refers to acrylate and methacrylate.

In an embodiment of the art disclosed herein, the primary component of the acrylic resin is an acrylic polymer containing methyl methacrylate (MMA) as a monomeric component. In usual, a copolymer of MMA and one, two or more other monomer species (in typical, mainly acrylic monomers excluding MMA) is preferable. Preferable examples of monomers usable as copolymerized components include (cyclo)alkyl (meth)acrylates excluding MMA. The term “(cyclo)alkyl” herein comprehensively refers to alkyl and cycloalkyl.

As the (cyclo)alkyl (meth)acrylate, can be used, for instance, alkyl acrylates with the alkyl group having 1 to 12 carbon atoms, such as methyl acrylate, ethyl acrylate, n-butyl acrylate, isobutyl acrylate, s-butyl acrylate, t-butyl acrylate, 2-ethylhexyl acrylate (2EHA), etc.; alkyl methacrylates with the alkyl group having 2 to 6 carbon atoms, such as ethyl methacrylate, n-butyl methacrylate, isopropyl methacrylate, isobutyl methacrylte, etc.; cycloalkyl acrylates with the cycloalkyl group having 5 to 7 carbon atoms, such as cyclopentyl acrylate, cyclohexyl acrylate, etc.; cycloalkyl methacrylates with the cycloalkyl group having 5 to 7 carbon atoms, such as cyclopentyl methacrylate, cyclohexyl methacrylate (CHMA), etc.; and the like.

As far as the effects by the present invention are not remarkably impaired, monomer(s) (other monomer(s)) besides those listed above may be copolymerized in the acrylic polymer. Examples of such monomers include carboxyl group-containing monomers (acrylic acid, methacrylic acid, itaconic acid, maleic acid, fumaric acid, etc.), acid anhydride group-containing monomers (maleic acid anhydride, itaconic acid anhydride, etc.), hydroxyl group-containing monomers (2-hydroxyethyl (meth)acrylate, etc.), vinyl esters (vinyl acetate, vinyl propionate, etc.), aromatic vinylic compounds (styrene, α-methylstyrene, etc.), amide group-containing monomers (acrylamide, N,N-dimethylacrylamide, etc.), amino group-containing monomers (aminoethyl (meth)acrylate, N,N-dimethylaminoethyl (meth)acrylate, etc.), imide group-containing monomers (e.g., cyclohexylmaleimide), epoxy group-containing monomers (e.g., glycidyl (meth)acrylate), (meth)acryloylmorpholines, vinyl ethers (e.g., methyl vinyl ether), and the like. It is usually preferable that the copolymerization ratio of these “other monomer(s)” (when two or more kinds are used, their total amount) is 20% by mass or less or may be 10% by mass or less, or such a monomer may not be essentially copolymerized.

In another embodiment of the art disclosed herein, the binder resin is a resin (polyester resin) comprising a polyester as a base polymer (the primary component among polymer components, i.e., a component accounting for 50% by mass or greater).

There are no particular limitations to the polyester resin, and can be used a resin comprising, as a base polymer, a polyester resin obtainable by dehydration condensation of various polybasic acid components and polyol components by a known method.

Examples of polybasic acid components include aromatic dibasic acids such as terephthalic acid, isophthalic acid, phthalic acid, naphthalene dicarboxylic acid, 5-sulfoisophthalic acid (salt), etc.; aliphatic dibasic acids such as succinic acid, glutaric acid, adipic acid, azelaic acid, sebacic acid, decane dicarboxylic acid, dodecanediioic acid, eicosanediioic acid, octadecane dicarboxylic acid, etc.; alicyclic dibasic acids such as hexahydrophthalic acid, methylhexahydrophthalic acid, 1,3-cyclohexane dicarboxylic acid, 1,4-cyclohexane dicarboxylic acid, etc.; dibasic acids having an unsaturated double bond, such as fumaric acid, dimer acid, α- and ω-1,2-polybutadiene dicarboxylic acid, 7,12-dimethyl-7,11-octadecadiene-1,18-dicarboxylic acid, etc., and their hydrogenation products as well as other polybasic acids besides those listed above, such as 8,9-diphenyl hexadecanediioic acid, trimellitic acid, etc. The polybasic acid component also includes reactive derivatives, etc., such as acid anhydrides of the polybasic acid components listed above and dimethyl terephthalate, etc. Among these components, one species can be used solely, or two or more species can be used as a mixture.

Examples of polyol components include ethylene glycol, 1,2-propyleneglycol, 1,3-propanediol, 1,2-butylene glycol, 1,3-butylene glycol, 1,4-butanediol, 1,5-pentanediol, 1,6-hexanediol, 1,10-decanediol, 1,4-cyclohexanediol, 1,4-cyclohexane dimethanol, diethylene glycol, triethylene glycol, dipropyleneglycol, tripropyleneglycol, polypropyleneglycol, neopentyl glycol, polyethylene glycol, polytetramethylene glycol as well as α- or ω-1,2-polybutadiene glycol, bisphenol A, bisphenol F, and their hydrogenation products.

The polyester resin may contain a lactone such as caprolactone, etc., or a hydroxylcarboxylic acid such as 4-hydroxybenzoic acid in part thereof or in whole.

In a preferable embodiment of the antistatic layer disclosed herein, the conductive polymer is a polythiophene (which may be a polythiophene doped with PSS), and the binder resin is an acrylic resin. Such a combination of a conductive polymer and a binder resin is suitable for forming a PSA sheet (e.g., a surface protection film) having great antistaticity while having a thinner antistatic layer.

In another preferable embodiment of the antistatic layer disclosed herein, the conductive polymer is a quaternary ammonium salt group-containing polymer. As a method for forming an antistatic layer containing such a polymer, can be preferably employed a method where a liquid composition (a coating composition for forming antistatic layers) containing the polymer is applied to a substrate and allowed to dry or cure.

In a preferable embodiment of the antistatic layer disclosed herein, the conductive inorganic substance is tin oxide, and the binder resin is a polyester resin.

### <Composition of Antistatic Layer (Other Ingredients)>

The art disclosed herein can be practiced preferably in an embodiment where the antistatic layer contains a crosslinking agent. As the crosslinking agent, a suitable one can be selected and used from those generally used for crosslinking of resins, such as melamine-based, isocyanate-based, epoxy-based crosslinking agents, and the like. With use of such a crosslinking agent, can be obtained an antistatic layer capable of anchoring more strongly.

For others, the antistatic layer in the art disclosed herein may contain as necessary additives such as antioxidants, colorants (pigments, dyes, etc.), fluidity-adjusting agents (thixotropic agents, thickening agents, etc.), film-forming agents, leveling agents, catalysts (e.g., UV-polymerization initiator in a composition containing a UV-curable resin).

### <Method for Forming Antistatic Agents>

The antistatic layer can be preferably formed by a method comprising applying a liquid composition (antistatic coating composition) to a first face of a substrate film, with the liquid composition being a dispersion or a solution of an antistatic ingredient ASu and other ingredients used as necessary dispersed or dissolved in a suitable solvent. For instance, a preferably employed method comprises: applying the antistatic coating composition to a first face of film, allowing it to dry, and subjecting the resultant to a curing process (a thermal treatment, a UV-ray treatment, etc.).

A preferred solvent to constitute the top-coat material composition can produce consistent dissolution or dispersion of the ingredients for forming antistatic layers. Such a solvent may be an organic solvent, water, or a mixture of these. As the organic solvent, can be used, for example, one, two or more species selected from esters such as ethyl acetate, etc.; ketones such as methyl ethyl ketone, acetone, cyclohexanone, etc.; cyclic ethers such as tetrahydrofuran (THF), dioxane, etc.; aliphatic or alicyclic hydrocarbons such as n-hexane, cyclohexane, etc.; aromatic hydrocarbons such as toluene, xylene, etc.; aliphatic or alicyclic alcohols such as methanol, ethanol, n-propyl alcohol, isopropyl alcohol, cyclohexanol, etc.; glycol ethers such as alkylene glycol monoalkyl ethers, dialkylene glycol monoalkyl ethers, etc.; and so on.

### <Thickness of Antistatic Layer>

In a preferable embodiment of the PSA sheet disclosed herein, the antistatic layer has an average thickness Dave of 2 nm or larger, but smaller than 1 μm. Too large a Dave tends to result in poorer anchoring between the PSA layer and the polyester film. A poorer anchoring may be likely to result in adhesive transfer to adherend surfaces. On the other hand, too small a Dave may result in insufficient antistaticity of the PSA sheet. In a preferable embodiment, Dave is 2 nm or larger, but 100 nm or smaller (typically 2 nm or larger, but smaller than 100 nm). Such a small Dave is advantageous also from the standpoint of increasing the transparency (and further the visual inspectability) of the PSA sheet. The art disclosed herein can be practiced preferably in an embodiment where Dave is 2 nm or larger, but 50 nm or smaller (typically smaller than 50 nm). Dave may be 2 nm or larger, but 30 nm or smaller (typically smaller than 30 nm), 2 nm or larger, but 20 nm or smaller (typically smaller than 20 nm), or 5 nm or larger, but 15 nm or smaller.

The thickness Dn of the antistatic layer can be obtained by observing cross sections of the PSA sheet with a transmission electron microscope (TEM). For instance, a sample of interest may be embedded in resin, and sliced ultrathin for TEM analysis of the sample's cross sections, and the resulting data can be used preferably as the thickness Dn of the antistatic layer in the art disclosed herein. As for the TEM, can be used a transmission electron microscope under model number “H-7650” available from Hitachi, Ltd. In the worked examples described later, the cross-sectional surface area of an antistatic layer was determined with respect to a cross section along a straight line crossing in the width direction (direction perpendicular to the flow direction of PSA composition) by binarizing an image taken over 250 nm of the width direction at an accelerating voltage of 100 kV and a magnification of ×60,000, and divided by the sample length (250 nm herein) in the viewing field to determine the actual thickness (average thickness within the viewing field) Dn of the antistatic layer. Prior to the resin-embedding, in order to make the antistatic layer more distinguishable, the sample may be subjected to a heavy metal staining process. The thickness Dn of an antistatic layer can also be determined by making a calibration curve with respect to correlation between the thickness obtained by TEM and data obtained by various other thickness measuring devices (e.g., a surface profile gauge, an interferometric thickness gauge, an infrared spectrometer, various X-ray diffractometers, etc.).

For the average thickness Dave of the antistatic layer in the art disclosed herein, the thickness Dn of the antistatic layer can be obtained at several (preferably two or more, more preferably three or more) different measurement points, and their arithmetic average value cab be used. For instance, the thickness Dn of the antistatic layer may be measured at three measurement points spaced at a constant interval (adjacent measurement points are desirably apart by 2 cm or more (e.g., about 5 cm or more)) along a straight line crossing the antistatic layer (e.g., a straight line crossing in the width direction) (each measurement point can be analysed by TEM and the thickness of the measurement point can be measured directly, or as described above, data obtained by a suitable thickness measuring device can be converted to the thickness based on the calibration curve), and the average thickness Dave can be determined by arithmetically averaging the results. In particular, for example, Dave can be determined by the thickness measurement method described later in the worked examples.

The antistatic layer in the art disclosed herein, in combination with the PSA layer containing an antistatic ingredient ASp, works to increase the antistaticity of the PSA sheet as a whole. Thus, without excessively elevating the required levels of antistaticity provided by the antistatic layer and the PSA layer, respectively, the PSA sheet as a whole can exhibit even greater antistaticiy. By this means, because it is unnecessary to excessively increase the antistatic ingredient contents in the antistatic layer and in the PSA layer, the antistaticity can be increased without largely impairing the anchoring and the less containing nature.

In addition to the effect of increasing the antistaticity of the PSA sheet as described above, the antistatic layer may bring out an effect (anticontamination effect) to prevent or suppress the event where the antistatic ingredient ASp in the PSA layer contaminates adherends. While it is not necessarily clear how such an effect is produced, for instance, it can be considered as follows: the antistatic ingredient ASu in the antistatic layer and the antistatic ingredient ASp in the PSA layer interact (e.g., via electrostatic attraction) to suitably retain the ASp within the PSA layer (in other words, to suppress excessive bleeding of ASp), whereby higher levels of antistaticity and less contaminating nature are attained at the same time.

### <PSA Layer>

The PSA layer in the art disclosed herein comprises an acrylic polymer as a base polymer, and an ionic compound as an antistatic ingredient ASp. In typical, it comprises, as the ionic compound, either an ionic liquid or an alkali metal salt, or both an ionic liquid and an alkali metal salt.

### <Antistatic Ingredient ASp (Ionic Liquid)>

The ionic liquid is firstly described. It is noted that in the art disclosed herein, the term “ionic liquid” (or an ambient temperature molten salt) refers to an ionic compound that is present as a liquid at room temperature (25° C.).

As the ionic liquid, can be used preferably one or more species among nitrogen-containing onium salts, sulfur-containing onium salts and phosphorous-containing onium salts. In a preferable embodiment, the PSA layer comprises an ionic liquid having at least one species of organic cation species represented by any of the following general formulas (A) to (E). According to such an ionic liquid, it is possible to obtain a PSA sheet having particularly great antistaticity.

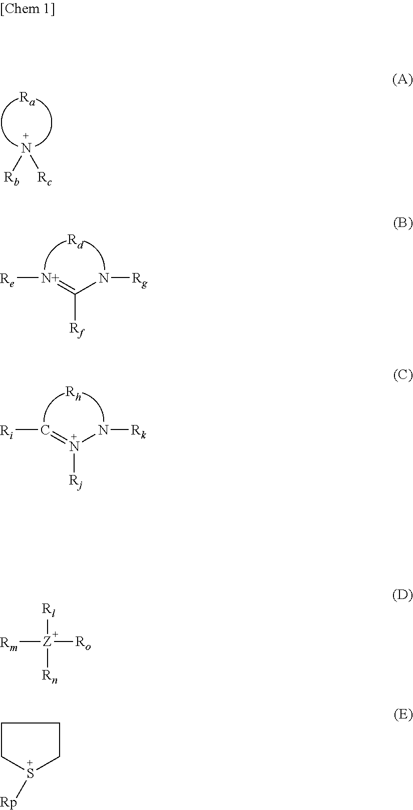

Here, in formula (A) above, Rₐ represents a hydrocarbon group having 4 to 20 carbon atoms, or a functional group containing a heteroatom. R_{b} and R_{c} may be the same or different, with each representing a hydrogen atom, a hydrocarbon group having 1 to 16 carbon atoms, or a functional group containing a heteroatom. However, R_{c} is not present in the case the nitrogen atom has a double bond.

In formula (B) above, R_{d} represents a hydrocarbon group having 2 to 20 carbon atoms, or a functional group containing a heteroatom. Rₑ, R_{f} and R_{g} may be the same or different, with each representing a hydrogen atom, a hydrocarbon group having 1 to 16 carbon atoms, or a functional group containing a heteroatom.

In formula (C) above, Rₕ represents a hydrocarbon group having 2 to 20 carbon atoms, or a functional group containing a heteroatom. Rᵢ, Rⱼ and Rₖ may be the same or different, with each representing a hydrogen atom, a hydrocarbon group having 1 to 16 carbon atoms, or a functional group containing a heteroatom.

In formula (D) above, Z represents a nitrogen atom, a sulfur atom or a phosphorous atom. Rₗ, Rₘ, Rₙ and Rₒ may be the same or different, with each representing a hydrocarbon group having 1 to 20 carbon atoms, or a functional group containing a heteroatom. However, Rₒ is not present in the case Z is a sulfur atom.

In formula (E) above, Rₚ represents a hydrocarbon group having 1 to 18 carbon atoms, or a functional group containing a heteroatom.

Examples of cations represented by formula (A) include a pyridinium cation, pyrrolidinium cation, piperidinium cation, cations having a pyrroline backbone, cations having a pyrrole backbone, and the like.

Specific examples of pyridinium cations include 1-methylpyridinium, 1-ethylpyridinium, 1-propylpyridinium, 1-butylpyridinium, 1-pentylpyridinium, 1-hexylpyridinium, 1-heptylpyridinium, 1-octylpyridinium, 1-nonylpyridinium, 1-decylpyridinium, 1-allylpyridinium, 1-propyl-2-methylpyridinium, 1-butyl-2-methylpyridinium, 1-pentyl-2-methylpyridinium, 1-hexyl-2-methylpyridinium, 1-heptyl-2-methylpyridinium, 1-octyl-2-methylpyridinium, 1-nonyl-2-methylpyridinium, 1-decyl-2-methylpyridinium, 1-propyl-3-methylpyridinium, 1-butyl-3-methylpyridinium, 1-butyl-4-methylpyridinium, 1-pentyl-3-methylpyridinium, 1-hexyl-3-methylpyridinium, 1-heptyl-3-methylpyridinium, 1-octyl-3-methylpyridinium, 1-octyl-4-methylpyridinium, 1-nonyl-3-methylpyridinium, 1-decyl-3-methylpyridinium, 1-propyl-4-methylpyridinium, 1-pentyl-4-methylpyridinium, 1-hexyl-4-methylpyridinium, 1-heptyl-4-methylpyridinium, 1-nonyl-4-methylpyridinium, 1-decyl-4-methylpyridinium, 1-butyl-3,4-dimethylpyridinium, and the like.

Specific examples of pyrrolidinium cations include 1,1-dimethylpyrrolidinium, 1-ethyl-1-methylpyrrolidinium, 1-methyl-1-propylpyrrolidinium, 1-methyl-1-butylpyrrolidinium, 1-methyl-1-pentylpyrrolidinium, 1-methyl-1-hexylpyrrolidinium, 1-methyl-1-heptylpyrrolidinium, 1-methyl-1-octylpyrrolidinium, 1-methyl-1-nonylpyrrolidinium, 1-methyl-1-decylpyrrolidinium, 1-methyl-1-methoxyethoxyethylpyrrolidinium, 1-ethyl-1-propylpyrrolidinium, 1-ethyl-1-butylpyrrolidinium, 1-ethyl-1-pentylpyrrolidinium, 1-ethyl-1-hexylpyrrolidinium, 1-ethyl-1-heptylpyrrolidinium, 1,1-dipropylpyrrolidinium, 1-propyl-1-butylpyrrolidinium, 1,1-dibutylpyrrolidinium, pyrrolidinium-2-one, and the like.

Specific examples of piperidinium cations include 1-propylpiperidinium, 1-pentylpiperidinium, 1,1-dimethylpiperidinium, 1-methyl-1-ethylpiperidinium, 1-methyl-1-propylpiperidinium, 1-methyl-1-butylpiperidinium, 1-methyl-1-pentylpiperidinium, 1-methyl-1-hexylpiperidinium, 1-methyl-1-heptylpiperidinium, 1-methyl-1-octylpiperidinium, 1-methyl-1-decylpiperidinium, 1-methyl-1-methoxyethoxyethylpiperidinium, 1-ethyl-1-propylpiperidinium, 1-ethyl-1-butylpiperidinium, 1-ethyl-1-pentylpiperidinium, 1-ethyl-1-hexylpiperidinium, 1-ethyl-1-heptylpiperidinium, 1,1-dipropylpiperidinium, 1-propyl-1-butylpiperidinium, 1-propyl-1-pentylpiperidinium, 1-propyl-1-hexylpiperidinium, 1-propyl-1-heptylpiperidinium, 1,1-dibutylpiperidinium, 1-butyl-1-pentylpiperidinium, 1-butyl-1-hexylpiperidinium, 1-butyl-1-heptylpiperidinium, and the like.

Specific examples of cations having a pyrroline backbone include 2-methyl-1-pyrroline and the like. Specific examples of cations having a pyrrole backbone include 1-ethyl-2-phenylindole, 1,2-dimethylindole, 1-ethylcarbazole, and the like.

Examples of cations represented by formula (B) include imidazolium cations, tetrahydropyrimidinium cations, dihydropyrimidinium cations, and the like.

Specific examples of imidazolium cations include 1,3-dimethylimidazolium, 1,3-diethylimidazolium, 1-methyl-3-ethylimidazolium, 1-methyl-3-hexylimidazolium, 1-ethyl-3-methylimidazolium, 1-propyl-3-methylimidazolium, 1-butyl-3-methylimidazolium, 1-pentyl-3-methylimidazolium, 1-hexyl-3-methylimidazolium, 1-heptyl-3-methylimidazolium, 1-octyl-3-methylimidazolium, 1-nonyl-3-methylimidazolium, 1-decyl-3-methylimidazolium, 1-dodecyl-3-methylimidazolium, 1-tetradecyl-3-methylimidazolium, 1-hexadecyl-3-methylimidazolium, 1-octadecyl-3-methylimidazolium, 1,2-dimethyl-3-propylimidazolium, 1-ethyl-2,3-dimethylimidazolium, 1-butyl-2,3-dimethylimidazolium, 1-hexyl-2,3-dimethylimidazolium, 1-(2-methoxyethyl)-3-methylimidazolium, and the like.

Specific examples of tetrahydropyrimidinium cations include 1,3-dimethyl-1,4,5,6-tetrahydropyrimidinium, 1,2,3-trimethyl-1,4,5,6-tetrahydropyrimidinium, 1,2,3,4-tetramethyl-1,4,5,6-tetrahydropyrimidinium, 1,2,3,5-tetramethyl-1,4,5,6-tetrahydropyrimidinium, and the like.

Specific examples of dihydropyrimidinium cations include 1,3-dimethyl-1,4-dihydropyrimidinium, 1,3-dimethyl-1,6-dihydropyrimidinium, 1,2,3-trimethyl-1,4-dihydropyrimidinium, 1,2,3-trimethyl-1,6-dihydropyrimidinium, 1,2,3,4-tetramethyl-1,4-dihydropyrimidinium, 1,2,3,4-tetramethyl-1,6-dihydropyrimidinium, and the like.

Examples of cations represented by formula (C) include pyrazolium cations, pyrazolinium cations, and the like.

Specific examples of pyrazolium cations include 1-methylpyrazolium, 3-methylpyrazolium, 1-ethyl-2,3,5-trimethylpyrazolium, 1-propyl-2,3,5-trimethylpyrazolium, 1-butyl-2,3,5-trimethylpyrazolium, 1-(2-methoxyethyl)pyrazolium, and the like. Specific examples of pyrazolinium cations include 1-ethyl-2-methylpyrazolinium and the like.

Examples of cations represented by formula (D) include a cation in which Rₗ, Rₘ, Rₙ and Rₒ may be the same or different, with each being an alkyl group having 1 to 20 carbon atoms. Examples of such a cation include tetraalkylammonium cations, trialkylsulfonium cations and tetraalkylphosphonium cations. Other examples of cations represented by formula (D) include those with some of the alkyl groups including a substituent such as an alkenyl group, an alkoxy group and/or an epoxy group. In addition, one, two or more of Rₗ, Rₘ, Rₙ and Rₒ may also contain an aromatic ring or an aliphatic ring.

The cation represented by formula (D) may have a symmetrical structure or an asymmetrical structure. Examples of ammonium cation having a symmetrical structure include tetraalkylammonium cations in which Rₗ, Rₘ, Rₙ and Rₒ are the same alkyl group (such as any of methyl group, ethyl group, propyl group, butyl group, pentyl group, hexyl group, heptyl group, octyl group, nonyl group, decyl group, dodecyl group, hexadecyl group or octadecyl group).

Typical examples of asymmetrical ammonium cations include a tetraalkylammonium cation in which three of Rₗ, Rₘ, Rₙ and Rₒ are the same while the remaining group is different, with specific examples thereof including asymmetrical tetraalkyl ammonium cations such as trimethylethylammonium, trimethylpropylammonium, trimethylbutylammonium, trimethylpentylammonium, trimethylhexylammonium, trimethylheptylammonium, trimethyloctylammonium, trimethylnonylammonium, trimethyldecylammonium, triethylmethylammonium, triethylpropylammonium, triethylbutylammonium, triethylpentylammonium, triethylhexylammonium, triethylheptylammonium, triethyloctylammonium, triethylnonylammonium, triethyldecylammonium, tripropylmethylammonium, tripropylethylammonium, tripropylbutylammonium, tripropylpentylammonium, tripropylhexylammonium, tripropylheptylammonium, tripropyloctylammonium, tripropylnonylammonium, tripropyldecylammonium, tributylmethylammonium, tributylethylammonium, tributylpropylammonium, tributylpentylammonium, tributylhexylammonium, tributylheptylammonium, tripentylmethylammonium, tripentylethylammonium, tripentylpropylammonium, tripentylbutylammonium, tripentylhexylammonium, tripentylheptylammonium, trihexylmethylammonium, trihexylethylammonium, trihexylpropylammonium, trihexylbutylammonium, trihexylpentylammonium, trihexylheptylammonium, triheptylmethylammonium, triheptylethylammonium, triheptylpropylammonium, triheptylbutylammonium, triheptylpentylammonium, triheptylhexylammonium, triocylmethylammonium, triocylethylammonium, trioctylpropylammonium, trioctylbutylammonium, trioctylpentylammonium, trioctylhexylammonium, trioctylheptylammonium, trioctyldodecylammonium, trioctylhexadecylammonium, trioctyloctadecylammonium, trinonylmethylammonium, tridecylmethylammonium, and the like.

Other examples of asymmetrical ammonium cations include tetraalkylammonium cations such as dimethyldiethylammonium, dimethyldipropylammonium, dimethyldibutylammonium, dimethyldipentylammonium, dimethyldihexylammonium, dimethyldiheptylammonium, dimethyldioctylammonium, dimethyldinonylammonium, dimethyldidecylammonium, dipropyldiethylammonium, dipropyldibutylammonium, dipropyldipentylammonium, dipropyldihexylammonium, dimethylethylpropylammonium, dimethylethylbutylammonium, dimethylethylpentylammonium, dimethylethylhexylammonium, dimethylethylheptylammonium, dimethylethylnonylammonium, dimethylpropylbutylammonium, dimethylpropylpentylammonium, dimethylpropylhexylammonium, dimethylpropylheptylammonium, dimethylbutylhexylammonium, dimethylbutylheptylammonium, dimethylpentylhexylammonium, dimethylhexylheptylammonium, diethylmethylpropylammonium, diethylmethylpentylammonium, diethylmethylheptylammonium, diethylpropylpentylammonium, dipropylmethylethylammonium, dipropylmethylpentylammonium, dipropylbutylhexylammonium, dibutylmethylpentylammonium, dibutylmethylhexylammonium, methylethylpropylbutylammonium, methylethylpropylpentylammonium, methylethylpropylhexylammonium, etc.; ammonium cations containing a cycloalkyl group such as trimethylcyclohexylammonium, etc.; ammonium cations containing an alkenyl group such as diallyldimethylammonium, diallyldipropylammonium, diallylmethylhexylammonium, diallylmethyloctylammonium, etc.; ammonium cations containing an alkoxy group such as triethyl(methoxyethoxyethyl)ammonium, dimethylethyl(methoxyethoxyethyl)ammonium, dimethylethyl(ethoxyethoxyethyl)ammonium, diethylmethyl(2-methoxyethyl)ammonium, diethylmethyl(methoxyethoxyethyl)ammonium, etc.; ammonium cations containing an epoxy group such as glycidyltrimethylammonium, etc.; and the like.

Examples of sulfonium cations having a symmetrical structure include trialkylsulfonium cations in which Rₗ, Rₘ, and Rₙ are the same alkyl group (such as any of methyl group, ethyl group, propyl group, butyl group and hexyl group). Examples of asymmetrical sulfonium cations include asymmetrical trialkylsulfonium cations such as dimethyldecylsulfonium, diethylmethylsulfonium, dibutylethylsulfonium, and the like.

Examples of phosphonium cations having a symmetrical structure include tetraalkylphosphonium cations in which Rₗ, Rₘ, Rₙ and Rₒ represent the same alkyl group (such as any of methyl group, ethyl group, butyl group, pentyl group, hexyl group, heptyl group, octyl group, nonyl group and decyl group). Examples of asymmetrical phosphonium cations include tetraalkylphosphonium cations in which three of Rₗ, Rₘ, Rₙ and Rₒ are the same while the remaining group is different, with specific examples thereof including trimethylpentylphosphonium, trimethylhexylphosphonium, trimethylheptylphosphonium, trimethyloctylphosphonium, trimethylnonylphosphonium, trimethyldecylphosphonium, triethylmethylphosphonium, tributylethylphosphonium, tributyl-(2-methoxyethyl)phosphonium, tripentylmethylphosphonium, trihexylmethylphosphonium, triheptylmethylphosphonium, trioctylmethylphosphonium, trinonylmethylphosphonium and tridecylmethylphosphonium. Other examples of asymmetrical phosphonium cations include asymmetrical tetraalkylphosphonium cations such as trihexyltetradecylphosphonium, dimethyldipentylphosphonium, dimethyldihexylphosphonium, dimethyldiheptylphosphonium, dimethyldioctylphosphonium, dimethyldinonylphosphonium and dimethyldidecylphosphonium, and phosphonium cations containing an alkoxy group such as trimethyl(methoxyethoxyethyl)phosphonium, dimethylethyl(methoxyethoxyethyl)phosphonium, and the like.

Preferable examples of the cation represented by formula (D) include asymmetrical tetraalkylammonium cations, asymmetrical trialkylsulfonium cations and asymmetrical tetraalkylphosphonium cations such as those listed above.

Examples of the cation represented by formula (E) include sulfonium cations in which Rₚ is an alkyl group having 1 to 18 carbon atoms. Specific examples of Rₚ include methyl group, ethyl group, propyl group, butyl group, hexyl group, octyl group, nonyl group, decyl group, dodecyl group, tridecyl group, tetradecyl group, octadecyl group, and the like.

The anion species of the ionic liquid is not particularly limited, and can be any anion capable of forming an ionic liquid as a salt with any of the cations disclosed herein. Specific examples include Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, (FSO₂)₂N⁻, (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, C₉H₁₉COO⁻, (CH₃)₂PO₄⁻, (C₂H₅)₂PO₄⁻, C₂H₅OSO₃⁻, C₆H₁₃OSO₃⁻, C₈H₁₇OSO₃⁻, CH₃(OC₂H₄)₂OSO₃⁻, C₆H₄(CH₃)SO₃⁻, (C₂F₅)₃PF₃⁻, CH₃CH(OH)COO⁻ and anions represented by the following formula (F).

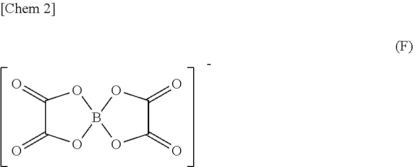

In particular, a hydrophobic anion species is less likely to bleed to the PSA surface, and is used preferably from the viewpoint of the less likelihood of causing contamination. In addition, an anion species containing a fluorine atom (such as an anion species containing a perfluoroalkyl group) is used preferably from the viewpoint of obtaining an ionic compound having a low melting point. Preferable examples of such an anion species include fluorine-containing anions such as bis(perfluoroalkylsulfonyl)imide anions (e.g., (CF₃SO₂)₂N⁻, (C₂F₅SO₂)₂N⁻), perfluoroalkylsulfonium anions (e.g., CF₃SO₃⁻), and the like. In usual, the number of carbon atoms in the perfluoroalkyl group is preferably 1 to 3 and particularly preferably 1 or 2.

The ionic liquid used in the art disclosed herein can be a suitable combination of the above-mentioned cation species and anion species. For example, in the case that cation species is a pyridinium cation, specific examples of combinations with the above-mentioned anion species include 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 1-allylpyridinium bis(trifluoromethanesulfonyl)imide, and the like. Similarly, with respect to the other cations listed above, can be used an ionic liquid thereof in a combination with an anion species disclosed herein.

For the ionic liquid, a commercially available product can be used. Alternatively, an ionic liquid can be easily synthesized according to a known method. There are no particular limitations on the method used to synthesize the ionic liquid as long as it allows production of the target ionic liquid. In general, can be employed a halogenation method, hydroxylation method, acid ester method, complex formation method, neutralization method or the like such as those described in the known literature, “Ionic Liquids—Front Line of Development and Future Outlook” (CMC Publishing Co., Ltd.). Patent Document 3 cited earlier also teaches a method for synthesizing an ionic liquid.

It is usually suitable that the amount of ionic liquid used is in a range of 0.01 to 10 parts by mass relative to 100 parts by mass of acrylic polymer, preferably 0.02 to 5 parts by mass, or more preferably 0.03 to 3 parts by mass. The amount of ionic liquid used can be 0.04 to 2 parts by mass, or 0.05 to 1 part by mass (e.g., 0.05 to 0.5 part by mass). With too small an amount of ionic liquid, sufficient antistaticity may not be obtained while too large an amount may tend to contaminate adherends. In the PSA sheet disclosed herein, due to the presence of an antistatic layer placed between a PSA layer comprising such an ionic liquid (antistatic agent ASp) and a polyester film, sufficient antistaticity can be obtained even if the ionic liquid is not used in a large excess. Thus, high levels of antistaticity and less contaminating nature can be attained at the same time.

### <Antistatic Ingredient ASp (Alkali Metal Salt)>

Typical examples of the alkali metal salt include lithium salts, sodium salts and potassium salts. For example, can be used a metal salt comprising Li⁺, Na⁺ or K⁺ as the cation species and Cl⁻, Br⁻, I⁻, BF₄⁻, PF₆⁻, SCN⁻, ClO₄⁻, CF₃SO₃⁻, (FSO₂)₂N⁻, (CF₃SO₂)₂N⁻, (C₂F₅SO₂)₂N⁻ or (CF₃SO₂)₃C⁻ as the anion species. The use of a lithium salt is preferable because of its high dissociation. Preferable specific examples of lithium salts include LiBr, LiI, LiBF₄, LiPF₆, LiSCN, LiClO₄, LiCF₃SO₃, Li(CF₃SO₂)₂N, Li(C₂F₅SO₂)₂N, Li(CF₃SO₂)₃C, and the like. A lithium salt containing, as its anion species, a fluorine-containing anion such as bis(perfluoroalkylsulfonyl)imide anion or perfluoroalkylsulfonium anion (such as Li(CF₃SO₂)₂N, Li(C₂F₅SO₂)₂N, or LiCF₃SO₃), etc., is particularly preferable. Among these alkali metal salts, one species may be used alone, or two or more species may be used in combination.

In usual, the amount of the alkali metal salt (e.g., a lithium salt) relative to 100 parts by mass of the acrylic polymer is suitably less than 1 part by mass, preferably 0.01 to 0.8 parts by mass, more preferably 0.01 to 0.5 parts by mass, or even more preferably 0.02 to 0.3 parts by mass (e.g., 0.05 to 0.2 parts by mass). If the amount of the alkali metal salt is excessively low, there may be cases in which adequate antistaticity cannot be obtained. On the other hand, if the amount of the alkali metal salt is excessively high, contamination of the adherend tends to occur easily.

The antistatic ingredient ASp in the antistatic layer disclosed herein may comprise, as necessary, an ionic compound as well as one, two or more other species of antistatic ingredient (conductive organic substances, conductive inorganic substances, antistatic agents, etc., excluding ionic compounds).

### <Acrylic Polymer>

Secondly, the acrylic polymer as a base polymer (the primary component among polymer components, i.e., a component accounting for 50% by mass or more) in the PSA layer disclosed herein is described.

The acrylic polymer is typically a polymer comprising an alkyl (meth)acrylate as a primary monomeric component. As the alkyl (meth)acrylate, can be preferably used, for instance, a compound represented by the following equation (1):

CH₂═C(R¹)COOR² (1)

Herein, R¹ in the equation (1) is a hydrogen atom or a methyl group. R² is an alkyl group having 1 to 20 carbon atoms. Because of the likelihood of resulting in a PSA having great adhesive properties, preferable is an alkyl (meth)acrylate with R² being an alkyl group having 1 to 14 carbon atoms (hereinafter, such a range of carbon atoms may be represented by C₁₋₁₄). Specific examples of C₁₋₁₄ alkyl groups include methyl group, ethyl group, propyl group, isopropyle group, n-butyl group, isobutyl group, s-butyl group, t-butyl group, n-pentyl group, isoamyl group, neopentyl group, n-hexyl group, n-heptyl group, n-octyl group, isooctyl group, 2-ethylhexyl group, n-nonyl group, isononyl group, n-decyl group, isodecyl group, n-undecyl group, n-dodecyl group, n-tridecyl group, n-tetradecyl group, and the like.

In a preferable embodiment, of the total amount of monomers used for synthesis of the acrylic polymer, one, two or more species selected from alkyl (meth)acrylates with R² in the equation (1) being C₁₋₁₄ account for about 50% by mass or more (typically 50 to 99.9% by mass), more preferably 70% by mass or more (typically 70 to 99.9% by mass), for instance, about 85% by mass or more (typically 85 to 99.9% by mass). According to an acrylic polymer obtained from such a monomer composition, a PSA having good adhesive properties may be preferably formed.

As the acrylic polymer in the art disclosed herein, it is preferable to use a polymer in which an acrylic monomer having a hydroxyl group (—OH) is copolymerized. Specific examples of an acrylic monomer having a hydroxyl group include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 2-hydroxyhexyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, polypropylene glycol mono(meth)acrylate, N-hydroxyethyl(meth)acrylamide, N-hydroxypropyl(meth)acrylamide, and the like. Among such hydroxyl group-containing acrylic monomers, can be used one species solely, or two or more species in combination. An acrylic polymer in which such a monomer has been copolymerized is preferable because it tends to yield a PSA that exhibits adhesive properties suitable for surface protection film. For example, since the peel strength to an adherend can be easily adjusted to a low level, a highly removable PSA can be readily obtained. Particularly preferable examples of a hydroxyl group-containing acrylic monomer include hydroxyl group-containing (meth)acrylates, such as 2-hydroxyethyl (meth)acrylate, 2-hydroxypropyl (meth)acrylate, 3-hydroxypropyl (meth)acrylate, 2-hydroxybutyl (meth)acrylate and 4-hydroxybutyl (meth)acrylate.

Of the total amount of monomers used to synthesize the acrylic polymer, such a hydroxyl group-containing acrylic monomer is preferably used within a range of about 0.1 to 15% by mass, more preferably within a range of about 0.2 to 10% by mass, and particularly preferably within a range of about 0.3 to 8% by mass. When the hydroxyl group-containing acrylic monomer content is excessively greater than the above ranges, the cohesive strength of the PSA becomes excessively large and the fluidity decreases, whereby the wettability (adhesion) to the adherend may tend to decrease. On the other hand, when the hydroxyl group-containing acrylic monomer content is excessively less than the above ranges, it may become difficult to attain the effect obtainable by use of the monomer to a satisfactory degree.

From the viewpoint of the ease of achieving balanced adhesive performance, an acrylic polymer having a glass transition temperature (Tg) of about 0° C. or below (typically, −100° C. to 0° C.) is usually used for the acrylic polymer in the art disclosed herein. An acrylic polymer having a Tg within the range of roughly −80° C. to −5° C. is more preferable. When the Tg value is excessively higher than the above ranges, the initial adhesiveness may be likely to be insufficient around ambient temperature, and workability of adhering a protection film may decrease. The Tg of the acrylic polymer can be adjusted by suitably modifying the monomer composition (namely, the types and usage ratio of monomers used in synthesis of the polymer).

Other monomers besides those described above may also be copolymerized in the acrylic polymer in the art disclosed herein within a range that does not remarkably impair the effects of the present invention. Such other monomers can be used for the purpose of, for example, adjusting the Tg of the acrylic polymer or adjusting the adhesive properties (e.g., removability). Examples of monomers capable of increasing the cohesive strength and the heat resistance of a PSA include sulfonic acid group-containing monomers, phosphoric acid group-containing monomers, cyano group-containing monomers, vinyl esters, aromatic vinyl compounds, and so on. In addition, examples of monomers that can introduce a functional group into the acrylic polymer that can become a crosslinking site or contribute to an increase in the adhesive strength include carboxyl group-containing monomers, acid anhydride group-containing monomers, amide group-containing monomers, amino group-containing monomers, imide group-containing monomers, epoxy group-containing monomers, (meth)acryloylmorpholines, vinyl ethers, and so on.

Examples of sulfonic acid group-containing monomers include styrene sulfonic acid, allyl sulfonic acid, 2-(meth)acrylamido-2-methylpropanesulfonic acid, (meth)acrylamidopropanesulfonic acid, sulfopropyl (meth)acrylate, (meth)acryloxynaphthalene sulfonic acid, sodium vinylsulfonate and the like.

Examples of phosphoric acid group-containing monomers include 2-hydroxyethyl acryloyl phosphate.

Examples of cyano group-containing monomers include acrylonitrile, methacrylonitrile and the like.

Examples of vinyl esters include vinyl acetate, vinyl propionate, vinyl laurate, and the like.

Examples of aromatic vinyl compounds include styrene, chlorostyrene, chloromethylstyrene, α-methylstyrene, other substituted styrenes, and the like.

Examples of carboxyl group-containing monomers include (meth)acrylic acid, carboxyethyl (meth)acrylate, carboxypentyl (meth)acrylate, itaconic acid, maleic acid, fumaric acid, crotonic acid, isocrotonic acid, and the like.

Examples of acid anhydride group-containing monomers include maleic anhydride, itaconic anhydride, acid anhydrides of the carboxyl group-containing monomers, and the like.

Examples of amide group-containing monomers include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropyl methacrylamide, diacetone acrylamide, and the like.

Examples of amino group-containing monomers include aminoethyl (meth)acrylate, N,N-dimethylaminoethyl (meth)acrylate and N,N-dimethylaminopropyl (meth)acrylate.

Examples of imide group-containing monomers include cyclohexylmaleimide, isopropylmaleimide, N-cyclohexylmaleimide, itaconimide, and the like.

Examples of epoxy group-containing monomers include glycidyl (meth)acrylate, methylglycidyl (meth)acrylate, allyl glycidyl ether, and the like.

Examples of vinyl ethers include methyl vinyl ether, ethyl vinyl ether, isobutyl vinyl ether, and the like.

While among these “other monomers”, one species can be used solely, or two or more species can be used in combination, their total content in the monomers used to synthesize the acrylic polymer is preferably about 40% by mass or less (typically, 0.001 to 40% by mass), and more preferably about 30% by mass or less (typically, 0.001 to 30% by mass). Also, the acrylic polymer may have a composition free of the other monomers (which may be an acrylic polymer obtained with only a C₆₋₁₄ alkyl (meth)acrylate as the monomer, or obtained with only a C₆₋₁₄ alkyl (meth)acrylate and a hydroxyl group-containing (meth)acrylate).

When a monomer having an acid functional group such as a carboxyl group, sulfonic acid group, phosphoric acid group, etc., (e.g., an acrylic monomer having such an acid functional group) is used as the other monomer, it is preferable to use it within a range that yields an acrylic polymer having an acid value of about 40 mgKOH/g or smaller (preferably 29 mgKOH/g or smaller, more preferably 16 mgKOH/g or smaller, even more preferably 8 mgKOH/g or smaller, or particularly preferably 4 mgKOH/g or smaller). This enables suppression of a decrease in the adhesive strength of protection film adhered on an adherend (furthermore, the peel strength to the adherend) over time and allows it to maintain good removability. The acid value of the acrylic polymer can be adjusted by modifying the amount of the acid functional group-containing monomer (i.e., the monomer composition), and so on. For example, for an acrylic polymer formed only with 2-ethylhexyl acrylate and acrylic acid as monomers, by using acrylic acid in an amount of 5.1 parts by mass or less in a total of 100 parts by mass of these monomers, can be obtained an acrylic polymer that satisfies the acid value of 40 mgKOH/g or smaller.

The acrylic polymer in the art disclosed herein has a weight average molecular weight (Mw) in a range of preferably 10×10⁴ or larger, but 500×10⁴ or smaller, more preferably 20×10⁴ or larger, but 400×10⁴ or smaller, or even more preferably 30×10⁴ or larger, but 300×10⁴ or smaller. Herein, Mw refers to a value obtained by GPC (gel permeation chromatography) based on standard polystyrene. When Mw is excessively smaller than these ranges, adhesive transfer to adherend surfaces may be likely to occur. On the other hand, when Mw is excessively larger than these ranges, the fluidity of PSA may become lower, and the wettability (adhesion) to adherends may be likely to turn out insufficient. Such insufficient wettability may cause the PSA sheet adhered on an adherend to peel off the adherend while in use (e.g., in case of surface protection film, unintentionally when continued protection is still desired).

The method for obtaining an acrylic polymer having such a monomer composition is not particularly limited. The polymer can be obtained by applying various polymerization methods generally employed as synthetic methods of acrylic polymers, such as solution polymerization, emulsion polymerization, bulk polymerization, suspension polymerization, and the like. The acrylic polymer may be a random copolymer, block copolymer, graft copolymer, or the like. From the standpoint of the productivity, etc., a random copolymer is usually preferable.

### <(Poly)Oxyalkylene Oxide Chain>

In a preferable embodiment of the art disclosed herein, the PSA layer comprises a (poly)alkylene oxide chain. A PSA layer having such a composition may have even lesser contaminating nature. While the reason is not necessarily clear, for instance, it can be considered that the presence of a (poly)alkylene oxide chain suppresses bleeding of antistatic ingredients. The (poly)alkylene oxide chain may be contained in a form of a (poly)alkylene oxide chain-containing monomer copolymerized in the acrylic polymer. Alternatively, it may be contained in a form of a (poly)alkylene oxide compound added (added afterwards) to the acrylic polymer.

As the (poly)alkylene oxide chain-containing monomer, can be used a (poly)alkylene oxide compound having in a molecule an oxyalkylene residue ((poly)alkylene oxide chain) and a polymerizable functional group (acryloyl group, methacryloyl group, allyl group, vinyl group, etc.) capable of copolymerizing with an acrylic monomer. Here, the scope of (poly)alkylene oxide compound encompasses both an alkylene oxide compound having one oxyalkylene residue as well as a polyalkylene oxide compound having two or more consecutive oxyalkylene residues (i.e., the number of sequential oxyalkylene residues is two or more). Such a (poly)alkylene oxide chain-containing monomer may be a so-called reactive surfactant. The alkylene group contained in the oxyalkylene residue has, for instance, 1 to 6 carbon atoms. The alkylene group may be a straight chain or a branched chain. Preferable examples include oxymethylene group, oxyethylene group, oxypropylene group, oxybutylene group and the like.

In a preferable embodiment, the (poly)alkylene oxide chain-containing monomer has a (poly)ethylene oxide chain. The monomer may comprise a (poly)ethylene oxide chain as a portion of its (poly)alkylene oxide chain. With use of an acrylic polymer in which such a monomer is copolymerized as the base polymer, the miscibility between the base polymer and the antistatic ingredient may increase and the bleeding to the adherend may be suppressed, whereby a less-contaminating PSA composition can be obtained.

From the standpoint of the miscibility with antistatic ingredients, etc., the (poly)alkylene oxide chain-containing monomer comprises an average of preferably 1 to 50, or more preferably 2 to 40 moles of oxyalkylene residues added (as the number of sequential residues). By copolymerizing a (poly)alkylene oxide chain-containing monomer with an average of one mole or more of sequential oxyalkylene residues, the less contaminating nature may be efficiently increased. When the average number of moles is excessively larger than 50, the interactions with antistatic ingredients may become excessively extensive, imparing ion conduction and giving rise to a tendency of a decrease in the antistaticity. The terminal hydroxyl group of the oxyalkylene chain may remain unreacted, or may have been substituted with a different functional group or the like.

Specific examples of a monomer having a (meth)acryloyl group and a (poly)alkylene oxide chain in a molecule thereof include polyethylene glycol (meth)acrylate, polypropylene glycol (meth)acrylate, polyethylene glycol-polypropylene glycol (meth)acrylate, polyethylene glycol-polybutylene glycol (meth)acrylate, polypropylene glycol-polybutylene glycol (meth)acrylate, methoxy polyethylene glycol (meth)acrylate, ethoxy polyethylene glycol (meth)acrylate, butoxy polyethylene glycol (meth)acrylate, octoxy polyethylene glycol (meth)acrylate, lauroxy polyethylene glycol (meth)acrylate, stearoxy polyethylene glycol (meth)acrylate, phenoxy polyethylene glycol (meth)acrylate, methoxy polypropylene glycol (meth)acrylate, octoxy polyethylene glycol-polypropylene glycol (meth)acrylate, and the like.

Examples of the reactive surfactant include anionic reactive surfactants, nonionic reactive surfactants and cationic reactive surfactants, etc., having the polymerizable functional group (acryloyl group, methacryloyl group, allyl group, vinyl group, etc.) and a (poly)alkylene oxide chain in a molecule thereof.

Specific examples of commercially available products that can be used as the (poly)alkylene oxide chain-containing monomer disclosed herein include trade names “BLENMER PME-400”, “BLENMER PME-1000” and “BLENMER 50POEP-800B” available from NOF Corporation; trade names “LATEMUL PD-420” and “LATEMUL PD-430” available from Kao Corporation; and trade names “ADEKA REASOAP ER-10” and “ADEKA REASOAP NE-10” available from Adeka Corporation; and the like.

Among the (poly)alkylene oxide chain-containing monomer, one species can be used solely, or two or more species can be used in combination. Their overall amount used is preferably 70% by mass or less, more preferably 60% by mass or less and even more preferably 50% by mass or less of the total amount of monomers used to synthesize the acrylic polymer. When the amount of (poly)alkylene oxide chain-containing monomer is excessively larger than 70% by mass, the interactions with antistatic ingredients may become excessively extensive, imparing ion conduction and giving rise to a tendency of a decrease in the antistaticity.

As the (poly)alkylene oxide compound added (added afterwards) to the acrylic polymer, can be used, for instance, various species of (poly)alkylene oxide compound in which the alkylene group contained in the oxyalkylene residue has 1 to 6 (preferably 1 to 4, or more preferably 2 to 4) carbon atoms. The alkylene group can be a straight chain or a branched chain. From the standpoint of the miscibility with antistatic ingredients, etc., the average number of moles of oxyalkylene residues added (the number of sequential residues) is preferably 1 to 50 and more preferably 1 to 40.

Specific examples of (poly)alkylene oxide compounds include nonionic surfactants such as polyoxyalkylene alkyl amines, polyoxyalkylene diamines, polyoxyalkylene fatty acid esters, polyoxyalkylene sorbitan fatty acid esters, polyoxyalkylene alkyl phenyl ethers, polyoxyalkylene alkyl ethers, polyoxyalkylene alkyl allyl ethers, polyoxyalkylene alkyl phenyl allyl ethers, etc.; anionic surfactants such as polyoxyalkylene alkyl ether sulfate ester salts, polyoxyalkylene alkyl ether phosphate ester salts, polyoxyalkylene alkyl phenyl ether sulfate ester salts, polyoxyalkylene alkyl phenyl ether phosphate ester salts, etc.; as well as cationic surfactants and zwitterionic surfactants having a polyalkylene oxide chain, polyethers and their derivatives having a polyalkylene oxide chain, polyoxyalkylene-modified silicone, and the like. In addition, the (poly)alkylene oxide chain-containing monomer may also be added to the acrylic polymer as a (poly)alkylene oxide chain-containing compound. Among such (poly)alkylene oxide chain-containing compounds, one species may be used alone, or two or more species may be used in combination.

As a preferable example of the (poly)alkylene oxide compound, can be cited a polyether containing a (poly)alkylene oxide chain. Specific examples of such a polyether include polypropylene glycol (PPG)-polyethylene glycol (PEG) block copolymers, PPG-PEG-PPG block copolymers, PEG-PPG-PEG block copolymers, and the like. Derivatives of (poly)alkylene oxide compounds include terminally-etherified oxypropyelene group-containing compounds (PPG monoalkyl ethers, PEG-PPG monoalkyl ethers, etc.), terminally-acetylated oxypropylene group-containing compounds (terminally-acetylated PPG etc.) and the like.

Other preferable examples of a (poly)alkylene oxide compound include nonionic surfactants (which may be reactive surfactants) having a (poly)alkylene oxide group. Commercially available products of such nonionic surfactants include trade names “ADEKA REASOAP NE-10”, “ADEKA REASOAP SE-20N”, “ADEKA REASOAP ER-10” and “ADEKA REASOAP SR-10” available from Adeka Corporation; trade names “LATEMUL PD-420”, “LATEMUL PD-430”, “EMULGEN 120” and “EMULGEN A-90” available from Kao Corporation; trade name “NEWCOL 1008” available from Nippon Nyukazai Co., Ltd.; trade name “NOIGEN XL-100” available from Dai-ichi Kogyo Seiyaku Co, Ltd.; and the like.

In a preferable embodiment, the (poly)alkylene oxide compound has a (poly)ethylene oxide chain in at least a portion thereof. Mixing of such a compound ((poly)ethylene oxide chain-containing compound) increases the miscibility between the base polymer and the antistatic ingredient, whereby a less-contaminating PSA composition can be obtained with preferably suppressed bleeding thereof to the adherend.

With respect to the molecular weight of the (poly)alkylene oxide compound, a suitable compound has a number average molecular weight (Mn) of 10000 or less, with 200 to 5000 being usually preferable. If the Mn value is too far above 10000, the miscibility to the acrylic polymer decreases with likelihood to form a turbid PSA layer. If the Mn is too far below 200, contamination by the (poly)alkylene oxide compound may be likely to occur. The Mn herein refers to a value based on standard polystyrene.

The amount of the (poly)alkylene oxide compound used can be, for instance, relative to 100 parts by mass of the acrylic polymer, 0.01 to 40 parts by mass, preferably 0.05 to 30 parts by mass, or more preferably 0.1 to 20 parts by mass. Too small an amount used may result in an lower effect of preventing bleeding of antistatic ingredients while too large an amount used may be likely to lead to contamination due to the (poly)alkylene oxide compound.

### <PSA Composition>

The PSA layer in the art disclosed herein may be formed with a PSA composition (e.g., an aqueous emulsion) containing PSA layer-forming components including at least the acrylic polymer and the ionic compound in a liquid medium primarily comprising water, a PSA composition (e.g., an organic solvent solution) containing the PSA layer-forming components in a liquid medium primarily comprising an organic solvent, a PSA composition (solvent-free composition) essentially free of such a liquid medium, or the like. In typical, it is constituted so that the acrylic polymer contained in the PSA composition can be suitably crosslinked. Such crosslinks may allow formation of a PSA layer that exhibits properties suitable for use in a surface protection film. As a specific crosslinking means, can be preferably employed a method comprising: introducing crosslinking sites into the acrylic polymer by copolymerizing a monomer having a suitable functional group (a hydroxyl group, carboxyl group, etc.) and adding to the acrylic polymer a compound (crosslinking agent) capable of reacting with that functional group to form a crosslink. As the crosslinking agent, can be used various types of material used for crosslinking of general acrylic polymers, such as an isocyanate compound, an epoxy compound, a melamine-based compound, an aziridine compound, or the like. Among these crosslinking agents, one species may be used alone, or two or more types may be used in combination.

As the crosslinking agent, it is particularly preferable to use an isocyanate compound since the peel strength relative to the adherend can be readily adjusted to a suitable range. Examples of such an isocyanate compound include aromatic isocyanates such as tolylene diisocyanate, xylylene diisocyanate, etc.; alicyclic isocyanates such as isophorone diisocyanate, etc.; aliphatic isocyanates such as hexamethylene diisocyanate, etc.; and the like. More specific examples include lower aliphatic polyisocyanates such as butylene diisocyanate, hexamethylene diisocyanate, etc.; alicyclic isocyanates such as cyclopentylene diisocyanate, cyclohexylene diisocyanate, isophorone diisocyanate, etc.; aromatic diisocyanates such as 2,4-tolylene diisocyanate, 4,4′-diphenylmethane diisocyanate, xylylene diisocyanate, etc.; isocyanate adducts such as trimethylolpropane/tolylene diisocyanate trimer adduct (trade name “CORONATE L” available from Nippon Polyurethane Industry Co., Ltd.), trimethylolpropane/hexamethylene diisocayante trimer adduct (trade name “CORONALE HL” available from Nippon Polyurethane Industry Co., Ltd.), an isocyanurate of hexamethylene diisocyanate (trade name “CORONATE HX” available from Nippon Polyurethane Industry Co., Ltd.), etc.; and the like. Among these isocyanate compounds, one species may be used alone, or two or more types may be used in combination.

In addition, examples of epoxy compounds used as crosslinking agents include N,N,N,N′-tetraglycidyl-m-xylene diamine (trade name “TETRAD-X” available from Mitsubishi Gas Chemical Inc.), 1,3-bis(N,N-diglycidylaminomethyl)cyclohexane (trade name “TETRAD-C” available from Mitsubishi Gas Chemical Inc.), and the like. Examples of melamine-based resins include hexamethylol melamine and the like. Examples of commercially available aziridine derivatives include products of trade names “HDU”, “TAZM” and “TAZO” available from Sogo Pharmaceutical Co., Ltd.

The amount of crosslinking agent used can be suitably selected according to the composition and the structure (molecular weight, etc.) of the acrylic polymer or the manner of use, etc., of the PSA sheet (e.g., surface protection film). Normally, the amount of crosslinking agent used relative to 100 parts by mass of the acrylic polymer is suitably about 0.01 to 15 parts by mass, preferably about 0.1 to 10 parts by mass (e.g., about 0.2 to 5 parts by mass). If the amount of crosslinking agent is excessively low, the cohesive strength of the PSA may turn out insufficient, whereby residual adhesive may be likely to remain on the adherend. On the other hand, if the amount of crosslinking agent used is excessively high, the PSA may exhibit too high a cohesive strength with lower fluidity, whereby the wettability to the adherend may turn out insufficient, causing a peel.

The PSA composition may further contain various conventionally known additives as necessary. Examples of such additives include surface lubricants, leveling agents, antioxidants, preservatives, photostabilizing agents, ultraviolet (UV)-ray absorbing agents, polymerization inhibitors, silane coupling agents, and the like. A tackifier resin known and/or commonly used in a PSA composition comprising as the base polymer an acrylic polymer can be used.

### <Method for Forming PSA Layers>

The PSA layer in the art disclosed herein can be preferably formed, for instance, by a method (direct method) where a PSA composition as described above is directly applied to a substrate film having a pre-formed antistatic layer, and allowed to dry or cure. Alternatively, it can be formed by another method (transfer method) where a PSA composition is applied to a surface (release face) of a release liner and allowed to dry or cure to form a PSA layer on the surface, and this PSA layer is adhered and transferred to the substrate film having an antistatic layer. From the standpoint of anchoring, etc., of the PSA layer, usually, the direct method is preferably employed. When providing (typically, applying) the PSA composition, can be suitably employed various methods conventionally known in the field of PSA sheets, such as roll coating, gravure roll coating, reverse roll coating, roll brushing, spray coating, air knife coating, die coating, and the like. Drying of the PSA composition can be carried out with heating as necessary (such as by heating to about 60° C. to 150° C.). As for the means to cure the PSA layer, can be suitably employed heat, UV rays, laser rays, α-rays, β-rays, γ-rays, X-rays and an electron beam, etc. Although there are no particular limitations, the thickness of the PSA layer can be, for example, about 3 μm to 100 μm, and it is usually preferable to be about 5 μm to 50 μm.

In the PSA sheet disclosed herein, each of the antistatic layer and the PSA layer may have a form consisting of either a single layer or multiple layers. From the standpoint of the productivity or the transparency, etc., usually, a preferable PSA sheet comprises an antistatic layer and a PSA layer of which at least one consists of a single layer, or a more preferable PSA sheet comprises an antistatic layer and a PSA layer with each consisting of a single layer. The PSA sheet disclosed herein may be in an embodiment further comprising a layer besides the antistatic layer and the PSA layer to an extent where the effects by the present invention are not significantly impaired. For example, the PSA sheet may be in an embodiment where an optional layer (a single layer or multiple layers) is present between the antistatic layer and the substrate (polyester film), an embodiment where an optional layer (a single layer or multiple layers) is present between the antistatic layer and the PSA layer, an embodiment where an optional layer (a single layer or multiple layers) is present on the backface (second face) of the antistatic layer. From the standpoint of the productivity or the transparency, etc., it is advantageous that the PSA sheet is in an embodiment where an antistatic layer is formed directly (via no other layers) on a surface of a substrate and a PSA layer is formed directly (via no other layers) on the surface of the antistatic layer.

The PSA sheet disclosed herein may be provided in a form where a release liner is adhered to the adhesive face (i.e., in a form of a PSA sheet having a release liner), as necessary, for protecting the adhesive face (to be adhered to an adherend). For the substrate constituting the release liner, can be used a paper, a synthetic resin film, or the like. Because of the evenly smooth surface, a synthetic resin film can be used preferably. For instance, as the substrate of the release liner, can be preferably used various resin films (e.g., polyester films). The thickness of the release liner may be, for instance, about 5 μm to 200 μm, and it is usually preferable to be about 10 μm to 100 μm. Of the release liner, the face to be adhered to a PSA layer may have been subjected to a release treatment or anti-contamination treatment using a conventional release agent (e.g., a silicone-based, a fluorine-based, long-chain alkyl-based, aliphatic acid amide-based, etc.) or silica gel powder, etc.

### <Properties of PSA Sheet>

The PSA sheet according to a preferable embodiment exhibits antistaticity such that the electrostatic voltage generated during peeling is within ±1 kV (more preferably within ±0.9 kV, or even more preferably within ±0.8 kV) when measured by the method described later in the worked examples. In the evaluation of less contaminating nature carried out by the method described later in the worked examples, a preferable PSA sheet exhibits a contaminating level of S or G. In the evaluation of anchoring carried out by the method described later in the worked examples, a preferable PSA sheet exhibits an anchoring level of S or G.

Several experimental examples relating to the present invention are described below, although these specific examples are not intended to limit the scope of the invention. In the description that follows, unless noted otherwise, all references to “parts” and “%” are based on mass.

In the description below, the respective properties were measured or evaluated as follows.

### <Measurement of Glass Transition Temperature>

Glass transition temperatures (Tg) (° C.) were determined with a dynamic viscoelasticity measurement system (ARES, available from Rheometrics Scientific, Inc.) by the following method.

In particular, multiple sheets (thickness: 20 μm each) of an acrylic polymer were overlaid to a thickness of approximately 2 mm, and this was cut out into a cyrindrical pellet of 7.9 mm diameter to obtain a Tg measurement sample. The measurement sample was fixed on a jig having parallel plates of 7.9 mm diameter, and the temperature dependence of loss modulous G″ was analyzed with the dynamic viscoelasticity measurement system. The temperature at which the resulting G″ curve maximized was recorded as Tg (° C.). The measurement conditions were as follows:

Measurement: shear mode

Temperature range: −70° C. to 150° C.

Heating rate: 5° C./min

Frequency: 1 Hz

### <Measurement of Weight Average Molecular Weight>

Weight average molecular weights (Mw) were measured with a GPC system available from Tosoh Corporation (HLC-8220GPC) and determined based on standard polystyrene. The measurement conditions were as follows:

Sample concentration: 0.2% by weight (THF solution)

Sample injection volume: 10 μL

Eluent: THF

Flow rate: 0.6 ml/min

Measurement temperature: 40° C.

Columns:

Sample column: TSKguardcolumn SuperHZ-H (one piece)+TSKgel SuperHZM-H (two pieces)

Reference column: TSKgel SuperH-RC (one piece)

Detector: differential refractometer (RI)

### <Measurement of Acid Value>

Acid values (mgKOH/g) were measured with an automatic titrator (COM-550 available from Hiranuma Sangyo Co., Ltd.) and determined based on the following equation:

A={(Y−X)×f×5.611}/M

A: acid value (mgKOH/g)

Y: titer (mL) of a sample solution

X: titer (mL) of a solution containing 50 g of only a mixed solvent

f: factor of the titrant

M: weight (g) of the polymer sample

The measurement conditions were as follows:

Sample solution: Approximately 0.5 g of a polymer sample was dissolved in 50 g of a mixed solvent of toluene/2-propanol/distilled water at 50/49.5/0.5 (mass ratio) to obtain a sample solution.

Titrant: 0.1 N, potassium hydroxide 2-propanolic solution (available from Wako Pure Chemical Industries, Ltd., for neutralization value determination in petroleum product)

Electrode: glass electrode GE-101, reference electrode RE-201

Measurement mode: neutralization value test in petroleum product 1

### <Measurement of Thickness of Antistatic Layer>

The PSA sheet according to each example was cross-sectionally observed with a transmission electron microscope (TEM) to measure the thickness of the antistatic layer. Each PSA sheet was measured along a straight line crossing in its width direction (direction perpendicular to the flow direction of bar coater) with respect to points located at ¼, 2/4 and ¾ of the 200 mm width from one edge of the width direction toward the other edge. The thickness values at these three points were arithmetically averaged to determine the average thickness Dave.

### <Measurement of Voltage of Static Electricity Generated During Peeling>

The PSA sheet according to each example was cut to a size of 70 mm wide by 130 mm long; and after the release liner was removed therefrom, as shown in FIG. 3, it was pressure-bonded with a hand-held roller to the surface of a polarizing plate 54 (polarizing plate AGS1 available from Nitto Denko Corporation, width: 70 mm, length: 100 mm) adhered to a pre-neutralized acrylic plate 52 (trade name “ACRYLITE” available from Mitsubishi Rayon Co., Ltd., thickness: 1 mm, width: 70 mm, length: 100 mm), in such a way that one end of PSA sheet 50 extended over an edge of polarizing plate 54 by 30 mm.

After left in an environment at 23° C. and 50% RH for one day, the sample was set in a prescribed place on a 20 mm high sample support 56. The 30 mm long end of PSA sheet 50 extending over polarizing plate 54 was fixed to an automatic winder (not shown in the drawing) and peeled at a peel angle of 150° and a peel rate of 10 m/min. The potential of the surface of the adherend (polarizing plate) generated during this procedure was measured with a potential meter 60 (model number “KSD-0103” available from Kasuga Denki, Inc.) placed at a 100 mm high level above the center of polarizing plate 54. Measurements were taken in an environment at 23° C. and 50% RH.

### <Evaluation of Less Contaminating Nature>

The PSA sheet according to each example was cut to a size of 50 mm wide by 80 mm long; and after the release liner was removed therefrom, it was laminated onto a 70 mm wide by 100 mm long polarizing plate (polarizing plate AGS1 available from Nitto Denko Corporation, width: 70 mm, length: 100 mm) at a pressure of 0.25 MPa and a speed of 0.3 m/min. After this was left in an environment at 23° C. and 50% RH for two weeks, in the same environment, the PSA sheet was peeled away by hand from the polarizing plate. The level of contamination on the polarizing plate surface after the peeling was visually observed in comparison with a polarizing plate prior to adhesion of the PSA sheet. The evaluation standards were as follows:

S: no contamination was observed

G: minute contamination was observed with no practical problems

NG: apparent contamination was observed.

### <Evaluation of Anchoring>

The level of adhesion to a substrate was evaluated by a lattice-pattern cutting test (cross-cut test). In particular, into the adhesive face of the PSA sheet according to each example, a lattice pattern (1 mm square, 10 by 10 cells) was cut with a cutter, and cellophane tape (cellotape (registered trademark) No. 405 available from Nichiban Co., Ltd.) was adhered over the entire surface. The cellophane tape was adhered with a 2 kg roller moved over back and forth once. After left in an environment at 23° C. and 50% RH for 30 minutes, the state of any peel of the PSA was visually observed. The evaluation standards were as follows:

S: 0% peeled surface area (no peeling occurred)

G: less than 30% peeled surface area

NG: 30% or larger peeled surface area

The compositions used for fabrication of the PSA sheets according to the respective examples were prepared as follows:

### <Antistatic Coating Composition (D1)>

A solution (binder solution (A1)) containing 5% of an acrylic polymer (binder polymer (B1)) as a binder in toluene was obtained. The binder solution (A1) was prepared as follows: In particular, to a reaction vessel, 25 g of toluene was placed, and the temperature inside the reaction vessel was raised to 105° C. To the reaction vessel, was added dropwise continuously over two hours a mixture of 30 g of methyl methacrylate (MMA), 10 g of n-butyl acrylate (BA), 5 g of cyclohexyl methacrylate (CHMA), and 0.2 g of azobisisobutylonitrile (AIBN). After the dropwise addition was completed, the temperature inside the reaction vessel was adjusted to 110° C. to 115° C., and it was stored at the temperature range for three hours to carry out copolymerization reaction. After a lapse of three hours, to the reaction vessel, was added dropwise a mixture of 4 g of toluene and 0.1 g of AIBN, and the resultant was stored at the same temperature for one hour. Subsequently, the temperature inside the reaction vessel was cooled to 90° C. and the mixture was diluted with toluene and adjusted to 5% non-volatile content (NV).

To a beaker of volume 150 mL, were added 2 g of binder solution (A1) (containing 0.1 g of binder polymer (B1)) and 40 g of ethylene glycol monoethyl ether, and the resultant was mixed with stirring. To this beaker, were further added 1 g of 5.0% NV aqueous conductive polymer solution (C1) containing polyethylene dioxythiophene (PEDT) and polystyrene sulfonate (PSS), 10 g of ethylene glycol monomethyl ether, and 0.01 g of a melamine-based crosslinking agent; and the resultant was stirred for 20 minutes and sufficiently mixed. In this way, was prepared a 0.3% NV coating composition (D1) containing 50 parts of conductive polymer relative to 100 parts of binder polymer (B1) (base resin) (both based on solid contents) and further containing a melamine-based crosslinking agent.

### <Antistatic Coating Composition (D2)>

55 parts of quaternized N,N-dimethylaminoethyl methacrylate methylchloride, 40 parts of methyl methacrylate, and 5 parts of 2-methylimidazole were copolymerized using 0.2 part of an azo-based initiator (trade name “V-50” available from Wako Pure Chemical Industries, Ltd.) at 60° C. in 100 parts of a mixed solvent of ethanol/water (at 1/1 volume ratio), and the resultant was diluted with a mixed solvent of ethanol/water (at 1/1 volume ratio) to prepare 0.3% NV coating composition (D2).

### <Antistatic Coating Composition (D3)>

An antistatic agent under trade name “MICRO-SOLVER RMd-142” (available from Solvex Inc., 20 to 25% NV) containing a polyester resin as a binder and an oxidized tin product (tin oxide) was diluted with a mixed solvent of ethanol/water (at 1/1 volume ratio) to prepare a 0.5% NV coating composition (D3).

### <PSA Composition (G1)>

To a four-necked flask equipped with a stirring blade, thermometer, nitrogen gas inlet, condenser and addition funnel, were added 200 parts of 2-ethylhexyl acrylate (2EHA), 8 parts of 2-hydroxyethyl acrylate (HEA), 0.4 part of AIBN and 312 parts of ethyl acetate, and with the resulting mixture being gently stirred under a nitrogen gas flow while the liquid temperature inside the flask being kept around 65° C., polymerization reaction was carried out for 6 hours to prepare a 40% NV solution of an acrylic polymer (P1). The acrylic polymer (P1) had a Tg of −10° C. or below, a Mw of 55×10⁴, and an acid value of 0.0 mgKOH/g.

To 100 parts of a solution (containing 20 parts of acrylic polymer (P1)) obtained by diluting the acrylic polymer (P1) solution to 20% NV with addition of ethyl acetate, were added 0.04 part of 1-butyl-3-methylpyridinium bis(trifluoromethanesulfonyl)imide (trade name “CIL-312” available from Japan Carlit Co., Ltd., an ionic liquid having a liquid form at 25° C.), 0.3 part of isocyanurate of hexamethylene diisocyanate (trade name “CORONATE HX” available from Nippon Polyurethane Industry Co., Ltd.), and 0.4 part of dibutyltin dilaurate (1% ethyl acetate solution) as a crosslinking catalyst, and the resultant was mixed with stirring at 25° C. for about one minute. In this way, was prepared an acrylic PSA composition (G1) containing 0.2 part of an ionic liquid as an ionic compound relative to 100 parts of acrylic polymer (P1).

### <PSA Composition (G2)>

To 100 parts of a solution (containing 20 parts of acrylic polymer (P1)) obtained by diluting the acrylic polymer (P1) solution to 20% NV with addition of ethyl acetate, were added 0.02 part of lithium bis(trifluoromethanesulfonyl)imide, 0.28 part of polypropylene glycol-polyethylene glycol-polypropylene glycol (available from Aldrich Corporation, average molecular weight 2000, ethylene glycol group ratio 50% by weight), 0.5 part of isocyanurate of hexamethylene diisocyanate (trade name “CORONATE HX” available from Nippon Polyurethane Industry Co., Ltd.), and 0.4 part of dibutyltin dilaurate (1% ethyl acetate solution) as a crosslinking catalyst, and the resultant was mixed with stirring at 25° C. for about one minute. In this way, was prepared an acrylic PSA composition (G2) containing 0.1 part of a lithium salt as an ionic compound relative to 100 parts of acrylic polymer (P1).

### <PSA Composition (G3)>

To 100 parts of a solution (containing 20 parts of acrylic polymer (P1)) obtained by diluting the acrylic polymer (P1) solution to 20% NV with addition of ethyl acetate, were added 0.5 part of isocyanurate of hexamethylene diisocyanate (trade name “CORONATE HX” available from Nippon Polyurethane Industry Co., Ltd.) and 0.4 part of dibutyltin dilaurate (1% ethyl acetate solution) as a crosslinking catalyst, and the resultant was mixed with stirring at 25° C. for about one minute. In this way, was prepared an acrylic PSA composition (G3) free of an ionic compound.

### Fabrication of PSA Sheet

### Example 1

Coating composition (D1) was applied with a bar coater (#2) to a corona-treated surface of a 38 μm thick, 30 cm wide by 40 cm long, transparent polyethylene terephthalate (PET) film, of which one face (a first face) had been subjected to corona treatment. The applied composition was allowed to dry with heating at 130° C. for two minutes to prepare a substrate film (E1a) having a 10 nm thick antistatic layer on a first face of PET film. On top of the antistatic layer, PSA composition (G1) containing an ionic liquid was applied and allowed to dry with heating at 130° C. for two minutes to form a 15 μm thick PSA layer. To the PSA layer, a release-treated surface of a 25 μm thick PET film (release liner) pre-subjected to a release treatment with a silicone-based release agent was adhered to fabricate a PSA sheet according to the present example.

### Example 2

Using a bar coater (#9) in place of the bar coater (#2) in Example 1, was prepared a substrate film (E1b) having a 60 nm thick antistatic layer on a first face of PET film. In the same manner as Example 1 except that this substrate film (E1b) was used, a PSA sheet according to the present example was fabricated.

### Example 3

In the same manner as Example 1 except that PSA composition (G2) containing a lithium salt was used in place of PSA composition (G1), a PSA sheet according to the present example was fabricated.

### Example 4

In Example 1, substrate film (E1b) was used in place of substrate film (E1a) and PSA composition (G2) was used in place of PSA composition (G1). Otherwise in the same manner as Example 1, a PSA sheet according to the present example was fabricated.

### Example 5

Using coating composition (D2) in place of coating composition (D1) in Example 1, with a bar coater (#2), was prepared a substrate film (E2a) having a 10 nm thick antistatic layer on a first face of PET film. In the same manner as Example 1 except that this substrate film (E2a) was used and PSA composition (G2) was used in place of PSA composition (G1), a PSA sheet according to the present example was fabricated.

### Example 6

Using coating composition (D2) in place of coating composition (D1) in Example 1, with a bar coater (#9), was prepared a substrate film (E2b) having a 60 nm thick antistatic layer on a first face of PET film. In the same manner as Example 1 except that this substrate film (E2b) was used and PSA composition (G2) was used in place of PSA composition (G1), a PSA sheet according to the present example was fabricated.

### Example 7

Using coating composition (D3) in place of coating composition (D1) in Example 1, with a bar coater (#9), was prepared a substrate film (E3) having a 100 nm thick antistatic layer on a first face of PET film. In the same manner as Example 1 except that this substrate film (E3) was used and PSA composition (G2) was used in place of PSA composition (G1), a PSA sheet according to the present example was fabricated.

### Example 8

In the same manner as Example 1 except that PSA composition (G1) was directly applied to the first face of PET film, a PSA sheet according to the present example was fabricated. The constitution of this PSA sheet is equivalent to the constitutions of the PSA sheets according to Examples 1 and 2 without their antistatic layers.

### Example 9

In the same manner as Example 1 except that PSA composition (G2) was used in place of PSA composition (G1) and this PSA composition (G2) was directly applied to the first face of PET film, a PSA sheet according to the present example was fabricated. The constitution of this PSA sheet is equivalent to the constitutions of the PSA sheets according to Examples 3 to 7 without their antistatic layers.

### Example 10

In Example 1, substrate film (E1b) was used in place of substrate film (E1a), and PSA composition (G3) was used in place of PSA composition (G1). Otherwise in the same manner as Example 1, a PSA sheet according to the present example was fabricated.

### Example 11

Using coating composition (D2) in place of coating composition (D1) in Example 1, with a bar coater (#9), was prepared a substrate film (E2b) having a 60 nm thick antistatic layer on a first face of PET film. In the same manner as Example 1 except that this substrate film (E2b) was used and PSA composition (G3) was used in place of PSA composition (G1), a PSA sheet according to the present example was fabricated.

### Example 12

Using coating composition (D3) in place of coating composition (D1) in Example 1, with a bar coater (#9), was prepared a substrate film (E3) having a 100 nm thick antistatic layer on a first face of PET film. In the same manner as Example 1 except that this substrate film (E3) was used and PSA composition (G3) was used in place of PSA composition (G1), a PSA sheet according to the present example was fabricated.

Table 1 shows the results of the respective measurements and evaluations to which the PSA sheets according to Examples 1 to 12 were subjected along with summarized constitutions of the respective PSA sheets.

TABLE 1

| | | | | Relative to AG polarizing plate | | |
|---|---|---|---|---|---|---|
| | | | | Electrostatic | | |
| | Antistatic layer | | PSA layer | voltage | | |
| | Antistatic | | Antistatic | generated | Less | |
| | ingredient | Thickness | ingredient | during peeling | contaminating | |
| Ex. | (ASu) | (nm) | (ASp) | (kV) | nature | Anchoring |
| 1 | Polythiophene | 10 | Ionic liquid | −0.5 | S | S |
| 2 | Polythiophene | 60 | Ionic liquid | 0.0 | S | S |
| 3 | Polythiophene | 10 | Lithium salt | −0.1 | G | S |
| 4 | Polythiophene | 60 | Lithium salt | −0.3 | G | S |
| 5 | 4° ammonium | 10 | Lithium salt | −0.1 | G | G |
| | salt | | | | | |
| 6 | 4° ammonium | 60 | Lithium salt | −0.2 | G | G |
| | salt | | | | | |
| 7 | Tin oxide | 100 | Lithium salt | −0.8 | G | G |
| 8 | — | — | Ionic liquid | −3.8 | S | S |
| 9 | — | — | Lithium salt | −1.6 | NG | S |
| 10 | Polythiophene | 60 | — | −1.1 | S | S |
| 11 | 4° ammonium | 60 | — | −1.7 | S | S |
| | salt | | | | | |
| 12 | Tin oxide | 100 | — | −2.4 | S | S |

As shown in Table 1, in the PSA sheets of Example 8 and Example 9 having no antistatic layer between the PSA layer and the polyester film as well as in the PSA sheets of Examples 10 to 12 containing no antistatic ingredient in the PSA layer, high levels of antistaticity, less contaminating nature and anchoring were not attained at the same time.

On the contrary, with respect to the PSA sheets according to Examples 1 to 7 each comprising an antistatic layer containing antistatic ingredient ASu on the first face of polyester film and further comprising thereon an acrylic PSA layer containing antistatic ingredient ASp, the electrostatic voltage generated during peeling was within ±1 kV (in particular, −0.8 kV to 0.0 kV), exhibiting great antistaticity. These PSA sheets all had less contaminating nature and anchoring sufficient for practical use. Among these, Examples 1 to 4 using a polythiophene as ASu showed especially great anchoring while Examples 1 to 2 using an ionic liquid as ASp showed especially great less contaminating nature.

As evident from comparisons among the results of Examples 3 to 7 and Example 9, it was confirmed that, in addition to increasing the antistaticity of the PSA sheet, the presence of the antistatic layer between the PSA layer and the polyester film was also effective in enhancing the less contaminating nature of the PSA sheet.

### INDUSTRIAL APPLICABILITY

The PSA sheet disclosed herein is preferable as a surface protection film to protect optical components during manufacturing and transport, etc., with the optical components being constituents of liquid crystal display panels, plasma display panels (PDP), organic electroluminescence (EL) displays, and the like. Especially, it is useful as a surface protection film (optical surface protection film) applied to optical components such as polarizing plates (polarizing films), wave plates, retardation plates, optical compensation films, brightening films, light-diffusing sheets, reflective sheets, and the like to be used in liquid crystal display panels.

### REFERENCE SIGNS LIST

1: PSA sheet
12: polyester film (substrate film)
16: antistatic layer
20: PSA layer
30: release liner

1. A pressure sensitive adhesive sheet comprising:
a substrate film formed from a resin material;
a pressure-sensitive adhesive layer provided on a first face of the substrate film; and
an antistatic layer provided between the first face of the substrate film and the pressure-sensitive adhesive layer; and
wherein the pressure-sensitive adhesive layer comprises an acrylic polymer as a base polymer and an ionic compound as an antistatic ingredient ASp, and
the antistatic layer comprises an antistatic ingredient ASu.

2. The pressure-sensitive adhesive sheet according to claim 1, wherein the pressure-sensitive adhesive layer comprises, as the antistatic ingredient ASp, at least either an ionic liquid or an alkali metal salt.

3. The pressure-sensitive adhesive sheet according to claim 1, wherein the antistatic layer has an average thickness Dave of 2 nm or larger, but smaller than 1 μm.

4. The pressure-sensitive adhesive sheet according to claim 1, wherein the antistatic ingredient ASp comprises a lithium salt as a primary component.

5. The pressure-sensitive adhesive sheet according to claim 1, wherein the antistatic layer comprises, as the antistatic ingredient ASu, at least one of a polythiophene, a quaternary ammonium salt group-containing polymer and a tin oxide.

6. A surface protection film comprising the pressure-sensitive adhesive sheet according to claim 1.

7. The surface protection film according to claim 6 characterized by its use for surface protection of a polarizing plate.

8. The pressure-sensitive adhesive sheet according to claim 2, wherein the antistatic layer has an average thickness Dave of 2 nm or larger, but smaller than 1 μm.

9. The pressure-sensitive adhesive sheet according to claim 2, wherein the antistatic ingredient ASp comprises a lithium salt as a primary component.

10. The pressure-sensitive adhesive sheet according to claim 2, wherein the antistatic layer comprises, as the antistatic ingredient ASu, at least one of a polythiophene, a quaternary ammonium salt group-containing polymer and a tin oxide.

11. A surface protection film comprising the pressure-sensitive adhesive sheet according to claim 2.

12. The surface protection film according to claim 11 characterized by its use for surface protection of a polarizing plate.

13. The pressure-sensitive adhesive sheet according to claim 3, wherein the antistatic ingredient ASp comprises a lithium salt as a primary component.

14. The pressure-sensitive adhesive sheet according to claim 3, wherein the antistatic layer comprises, as the antistatic ingredient ASu, at least one of a polythiophene, a quaternary ammonium salt group-containing polymer and a tin oxide.

15. A surface protection film comprising the pressure-sensitive adhesive sheet according to claim 3.

16. The surface protection film according to claim 15 characterized by its use for surface protection of a polarizing plate.

17. The pressure-sensitive adhesive sheet according to claim 4, wherein the antistatic layer comprises, as the antistatic ingredient ASu, at least one of a polythiophene, a quaternary ammonium salt group-containing polymer and a tin oxide.

18. A surface protection film comprising the pressure-sensitive adhesive sheet according to claim 4.

19. The surface protection film according to claim 18 characterized by its use for surface protection of a polarizing plate.

20. A surface protection film comprising the pressure-sensitive adhesive sheet according to claim 5.
